(19) United States
(12) Patent Application Publication
(10) Pub. No.: US 2018/0215540 A1
(43) Pub. Date: Aug. 2, 2018

(54) VARIABLE ARTICLE HOLDING DEVICE, TRANSFER DEVICE, ROBOT HANDLING SYSTEM, AND METHOD FOR CONTROLLING TRANSFER DEVICE

(71) Applicant: KABUSHIKI KAISHA TOSHIBA, Minato-ku (JP)

(72) Inventors: Junya TANAKA, Tokyo (JP); Akihito OGAWA, Fujisawa (JP); Atsushi SUGAHARA, Kawasaki (JP); Hideichi NAKAMOTO, Tokyo (JP); Takafumi SONOURA, Yokohama (JP); Haruna ETO, Tokyo (JP)

(73) Assignee: KABUSHIKI KAISHA TOSHIBA, Minato-ku (JP)

(21) Appl. No.: 15/689,077

(22) Filed: Aug. 29, 2017

(30) Foreign Application Priority Data
Jan. 30, 2017 (JP) 2017-014248

(51) Int. Cl. B65G 1/04

(52) U.S. Cl. CPC B65G 1/0435; B65G 47/914

(57) ABSTRACT

According to one embodiment, a variable article holding device includes a first base part, a first holder, a second base part, a first driving mechanism, a protruding member, and a second driving mechanism. The first holder holds an article and is provided on the first base part. The second base part rotatably supports the first base part about a rotary axis. The first driving mechanism rotates the first base part. The second driving mechanism moves the protruding member in a direction crossing the rotary axis and is provided on the first base part.

### CROSS REFERENCE TO RELATED APPLICATION

This application is based upon and claims the benefit of priority from Japanese Patent Application No. 2017-014248, filed Jan. 30, 2017, the entire contents of which are incorporated herein by reference.

### FIELD

Embodiments described herein relate generally to a robot handling system using a transfer device with a variable article holding device.

### BACKGROUND

In recent years, in the field of distribution and logistics, there has been a growing need to automate operations due to the need to handle an increased number of articles (also referred to as loads, workpieces, or the like) resulting from expanded mail-order marketing and a labor shortage resulting from declining birthrate and aging population. Demand has been placed on automation of operations using roll box pallets that are carts on casters; the roll box pallet is enclosed on three outer peripheral sides and is open on one outer peripheral side, and provides a pallet function. One of such operations is an operation of unloading a variety of articles of several to several tens of kilograms loaded on carts are sequentially unloaded from the carts and loaded onto a conveyor.

In unloading-operation automation equipment which performs an unloading operation for box-shaped articles such as cardboard boxes, the unloading operation is achieved using an articulated manipulator with a hand device arranged at a tip portion thereof. As the hand device, a vacuum suction type utilizing vacuum suction pads is widely adopted. This is because the pressure inside a space where the vacuum suction pads contact an article is reduced to allow the article to be held based on a difference between the inside pressure and atmospheric pressure, enabling holding even of articles larger than the size of the hand device. Many conventional hand devices have a simple form in which a plurality of vacuum suction pads is arranged on a bottom surface of a flat plate on the assumption that an upper surface of each article is sucked and held. However, some articles are precluded from being handled using conventional hand devices based on the assumption that the upper surface of the article is held. Examples of such articles include those which have a sucked surface with a dimension smaller than the diameter of each of the vacuum suction pads, those in which wrapping paper may be broken due to the weight of the article when the upper surface of the article is sucked and held, and tall articles. When such articles are handled, another surface such as a side surface of the article needs to be held.

### BRIEF DESCRIPTION OF THE DRAWINGS

FIG. 1 is a diagram depicting an example configuration of a robot handling system according to a first embodiment;

FIG. 2A is a perspective view illustrating a transfer device when a holding device is in an upper-surface suction mode;

FIG. 2B is a perspective view illustrating the transfer device when the holding device is in a side surface suction mode;

FIG. 3A and FIG. 3B are a side view and a top view depicting the holding device in the upper-surface suction mode;

FIG. 4A and FIG. 4B are a side view and a top view depicting the holding device in the side surface suction mode;

FIG. 5A is a perspective view depicting the holding device in the upper-surface suction mode;

FIG. 5B is a perspective view depicting an example of how the holding device is oriented when an article is carried in the side surface suction mode;

FIG. 6A is a side view depicting a rod member provided with a range sensor at a tip portion thereof;

FIG. 6B and FIG. 6C are side views illustrating an example method of sensing the article using the rod member depicted in FIG. 6A;

FIG. 7A is a side view depicting the rod member provided with an image sensor and an illuminating device at a tip portion thereof;

FIG. 7B and FIG. 7C are side views illustrating an example method of sensing the article using the rod member depicted in FIG. 7A;

FIG. 8 is a block diagram illustrating a control system for the holding device according to the first embodiment;

FIG. 9A, FIG. 9B, and FIG. 9C are side views illustrating an example operation of the holding device in the upper-surface suction mode;

FIG. 10A, FIG. 10B, FIG. 10C, FIG. 10D, FIG. 10E, and FIG. 10F are side views illustrating an example of an operation of the holding device in the side surface suction mode;

FIG. 11A, FIG. 11B, FIG. 11C, FIG. 11D, and FIG. 11E are side views illustrating another example of the operation of the holding device in the side surface suction mode;

FIG. 12A, FIG. 12B, FIG. 12C, FIG. 12D, FIG. 12E, and FIG. 12F are side views illustrating yet another example of the operation of the holding device in the side surface suction mode;

FIG. 13 is a flowchart illustrating an example operation of the robot handling system in FIG. 1;

FIG. 14 is a flowchart illustrating a specific example of processing in step S1301 in FIG. 13;

FIG. 15 is a flowchart illustrating a specific example of processing in step S1302 in FIG. 13;

FIG. 16 is a flowchart illustrating a specific example of processing in step S1304 in FIG. 13;

FIG. 17 is a flowchart illustrating another specific example of the processing in step S1304 in FIG. 13;

FIG. 18 is a flowchart illustrating a specific example of processing in step S1306 in FIG. 13;

FIG. 19 is a flowchart illustrating a specific example of processing in step S1307 and step S1308 in FIG. 13;

FIG. 20A and FIG. 20B are a side view and a top view depicting a modification of the holding device according to the first embodiment;

FIG. 21 is a side view depicting another modification of the holding device according to the first embodiment;

FIG. 22A and FIG. 22B are a side view and a top view depicting yet another modification of the holding device according to the first embodiment;

FIG. 23A and FIG. 23B are a side view and a top view depicting still another modification of the holding device according to the first embodiment;

FIG. 24A and FIG. 24B are a side view and a top view depicting further another modification of the holding device according to the first embodiment;

FIG. 25A and FIG. 25B are a side view and a top view depicting further another modification of the holding device according to the first embodiment;

FIG. 26A and FIG. 26B are a side view and a top view depicting further another modification of the holding device according to the first embodiment;

FIG. 27A and FIG. 27B are a side view and a top view depicting further another modification of the holding device according to the first embodiment;

FIG. 28A and FIG. 28B are top views depicting a modification of the transfer device according to the first embodiment;

FIG. 29A is a side view depicting a holding device in the upper-surface suction mode according to a second embodiment;

FIG. 29B is a side view depicting the holding device in the upper-surface suction mode according to a second embodiment;

FIG. 30 is a block diagram illustrating a control system for the holding device according to the second embodiment;

FIG. 31A, FIG. 31B, FIG. 31C, FIG. 31D, FIG. 31E, and FIG. 31F are side views illustrating an example operation of the holding device in the side surface suction mode according to the second embodiment; and

FIG. 32 is a flowchart illustrating an example operation of the holding device in the side surface suction mode according to the second embodiment.

### DETAILED DESCRIPTION

According to one embodiment, a variable article holding device includes a first base part, a first holder, a second base part, a first driving mechanism, a protruding member, and a second driving mechanism. The first holder holds an article and is provided on the first base part. The second base part rotatably supports the first base part about a rotary axis. The first driving mechanism rotates the first base part. The second driving mechanism moves the protruding member in a direction crossing the rotary axis and is provided on the first base part.

Embodiments will be described below with reference to the accompanying drawings. The like components are denoted by the like reference numerals throughout the drawings, and duplicate description of these components is omitted.

### First Embodiment

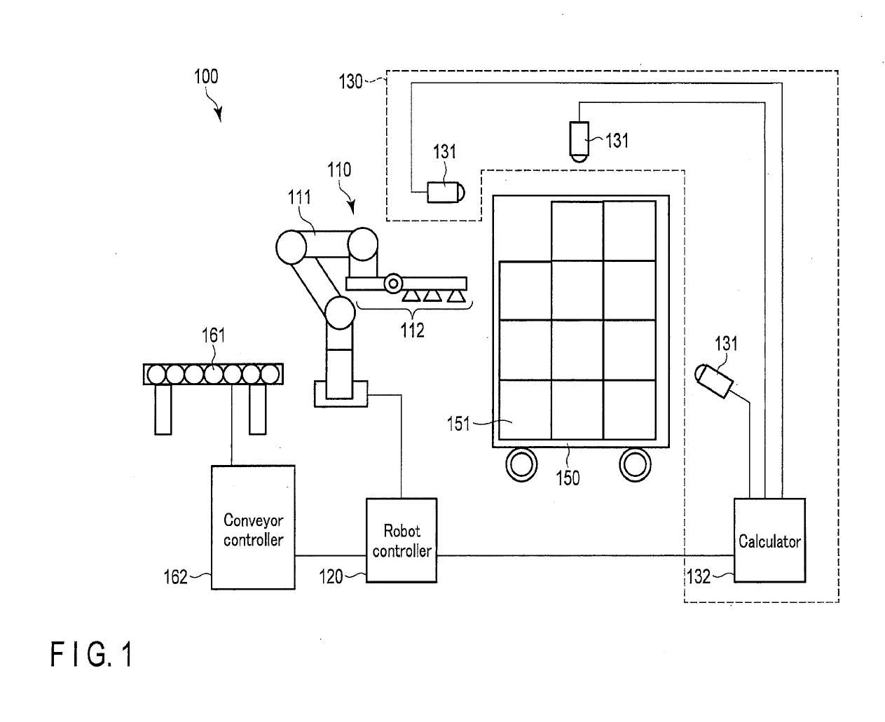

FIG. 1 schematically depicts a robot handling system 100 according to a first embodiment. As depicted in FIG. 1, the robot handling system 100 includes a transfer device 110, a robot controller 120, a three-dimensional position recognizing device 130, an automatic conveyor 161, and a conveyor controller 162. The transfer device 110 transfers articles 151 from a cage cart 150 to the automatic conveyor 161 one by one. Specifically, the transfer device 110 repeats an operation of taking out a selected one of the articles 151 loaded in the cage cart 150 and placing the taken-out article 151 onto the automatic conveyor 161. The cage cart 150 is a cart on casters which is enclosed by on three outer peripheral sides and is open on one outer peripheral side and which provides a pallet function. The cage cart 150 is also referred to as a roll box pallet or the like. The transfer device 110 may simultaneously transfer a plurality of the articles 151. The automatic conveyor 161 conveys the articles 151 loaded thereon. The automatic conveyor 161 is, for example, a roller conveyor. The conveyor controller 162 controls the automatic conveyor 161.

The three-dimensional position recognizing device 130 recognizes a three-dimensional position of each article 151 on the cage cart 150. Specifically, the three-dimensional position recognizing device 130 includes at least one range image sensor 131 and a calculator 132. In an example illustrated in FIG. 1, three range image sensors 131 are provided and fixed at a forward position, an upward position, and a sideward position with respect to the cage cart 150. The range image sensor 131 may be movable. The calculator 132 calculates the three-dimensional position of the article 151 based on sensor data output from the range image sensor 131. A sensor other than the range image sensor 131, for example, an image sensor, may be used. The robot controller 120 controls the transfer device 110 based on the output from the three-dimensional position recognizing device 130.

The transfer device 110 includes a manipulator 111 and a variable article holding device 112 attached to a tip portion of the manipulator 111. The variable article holding device is also referred to as a hand device. The variable article holding device 112 may simply be referred to as the holding device 112. In the present embodiment, the manipulator 111 is a vertically articulated robot. The manipulator 111 has a plurality of joints and can move the holding device 112 by rotating and/or linearly moving the joints. The holding device 112 is a holding device of a vacuum suction type. The holding device 112 may be of another type using, for example, an adhesive force, an electrostatic attractive force, or a magnetic attractive force.

The place where the articles 151 are loaded is not limited to the cage cart 150 but may be, for example, a pallet. The holding device 112 is not limited to a case where the holding device 112 is installed on the manipulator 111, and may be attached to a cart or the like. The transfer device 110 or the holding device 112 may be manually operated.

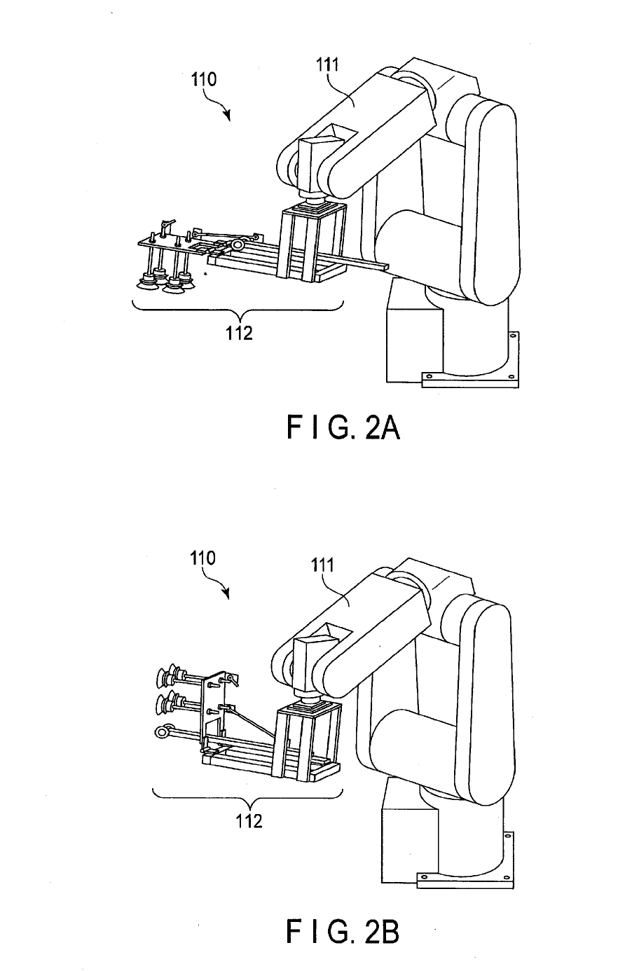

The structure of the holding device 112 will be described in detail. The holding device 112 has two modes, that is, an upper-surface suction mode in which an upper surface of the article is sucked and held as depicted in FIG. 2A and a side surface suction mode in which a side surface of the article is sucked and held as depicted in FIG. 2B. The holding device 112 can be switched between the upper-surface suction mode and the side surface suction mode depending on the state of the article to be taken out.

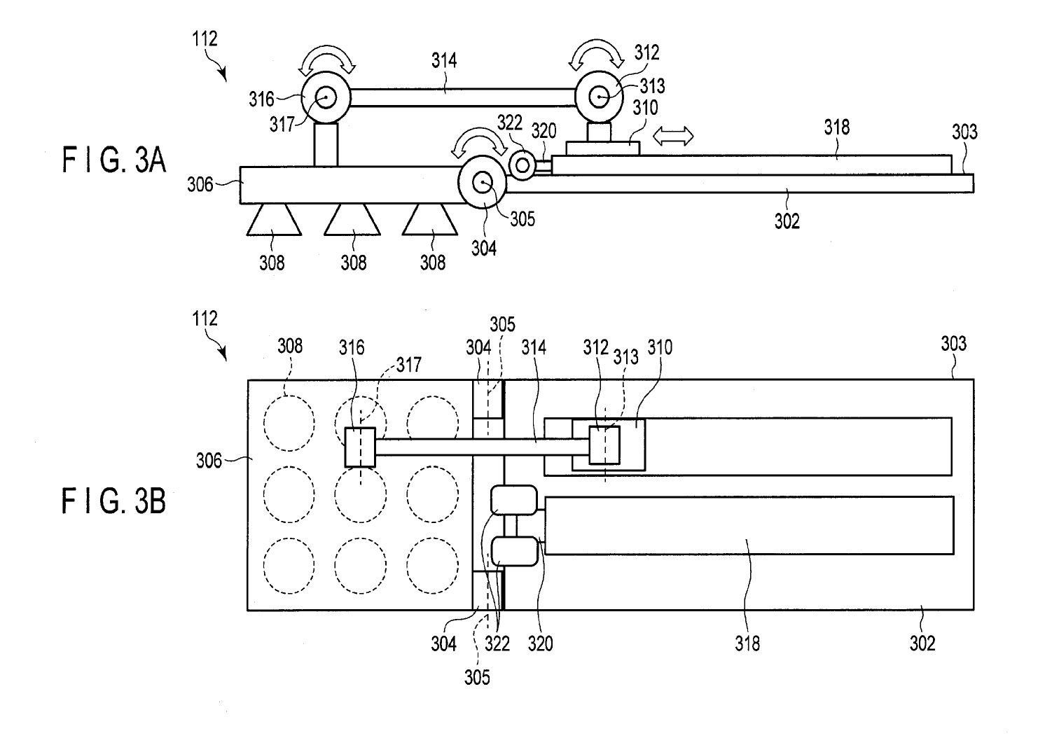

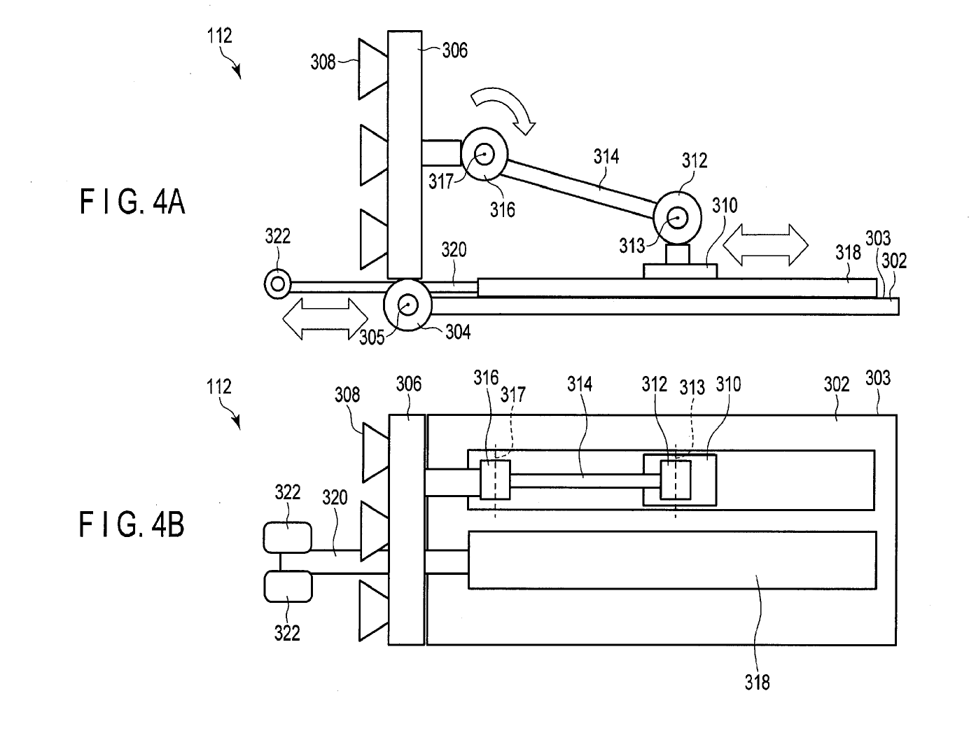

FIG. 3A and FIG. 3B are a side view and a top view schematically depicting the holding device 112 in the upper-surface suction mode. FIG. 4A and FIG. 4B are a side view and a top view schematically depicting the holding device 112 in the side surface suction mode. As depicted in FIG. 3A and FIG. 3B, the holding device 112 includes a base part 302, passive rotary joints 304, a base part 306, vacuum suction pads 308, a movable part 310, a passive rotary joint 312, a link member 314, a passive rotary joint 316, an active linear motion mechanism 318, a rod member 320, and passive rollers 322.

The base part 302 is attached to a tip portion of the manipulator 111 (depicted in FIG. 1). The base part 302 rotatably supports the base part 306. Specifically, the base part 302 is coupled to the base part 306 via the passive rotary joint 304. The passive rotary joint 304 can rotate about a rotary axis thereof. In an example illustrated in FIG. 3B, two passive rotary joints 304 are provided. The number of the passive rotary joints 304 may be varied in accordance with strength design or the like. For example, the single passive rotary joint 304 may be provided.

The vacuum suction pad 308 is provided on the base part 306. In an example illustrated in FIG. 3B, nine vacuum suction pads 308 are provided. It is noted that at least one vacuum suction pad 308 may be provided. The vacuum suction pads 308 hold the article by sucking the article in vacuum. A vacuum pump not depicted in the drawings is coupled to the vacuum suction pads 308. The vacuum pump evacuates the inside of the vacuum suction pads 308. The vacuum suction pads 308 are an example of a holder which holds the article. The vacuum pump is an example of a negative-pressure generator which generates a negative pressure applied to the vacuum suction pads 308. The negative-pressure generator may be a configuration in which a pressurizer and a vacuum generator are combined to generate a negative pressure. A selector valve may be arranged in the middle of piping between the vacuum pump and the vacuum suction pads 308 to optionally controllably start and stop suction. The selector valve may be of a type which is operated using a solenoid valve or an electric motor. A pressure generator such as a compressor may be connected to the selector valve via piping. In the configuration in which the vacuum suction pad 308 and the selector valve are connected together via piping and in which the selector valve, the negative-pressure generator, and the pressure generator are connected together via piping, the vacuum suction pads 308 can be switched between a negative pressure state and a positive pressure state at any timing by controlling the selector valve. Thus, the article can be smoothly sucked and released.

The movable part 310 is provided on an upper surface 303 of the base part 302 so as to be linearly movable on the upper surface 303 of the base part 302. A first end of the link member 314 is coupled to the movable part 310 via the passive rotary joint 312. The passive rotary joint 312 can rotate about a rotary axis thereof. The base part 306 is coupled to a second end of the link member 314 via the passive rotary joint 316. The passive rotary joint 316 can rotate about a rotary axis 317 thereof.

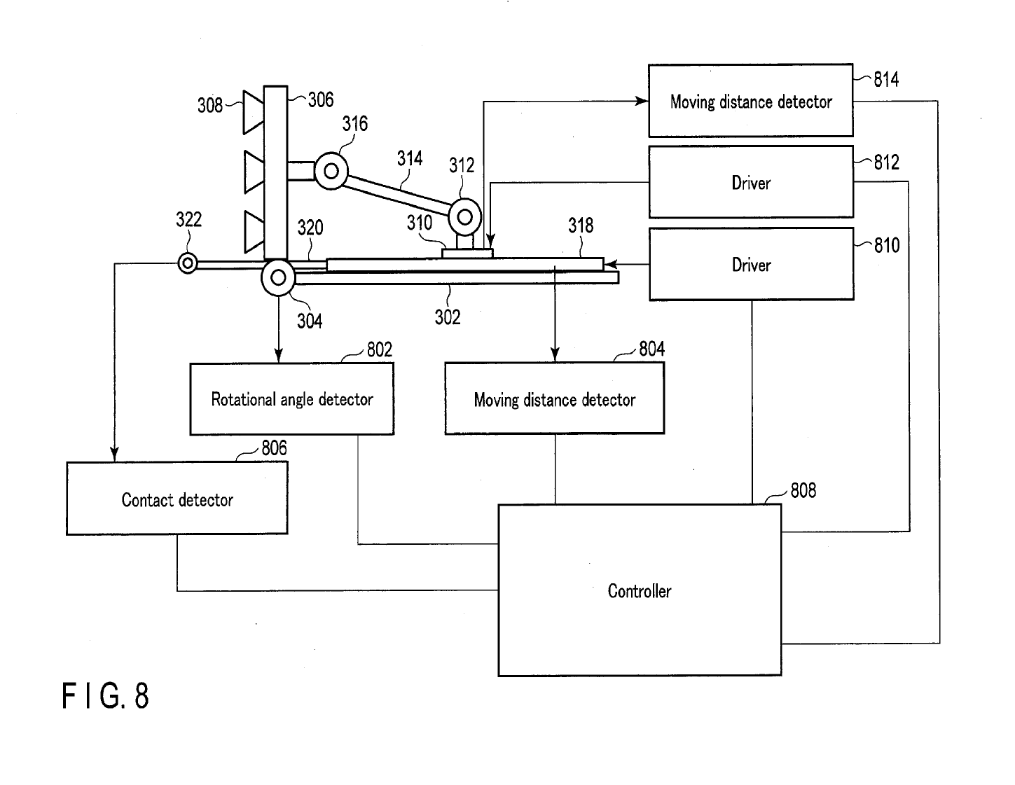

Switching between the upper-surface suction mode and the side surface suction mode is achieved by moving the movable part 310. To switch from the upper-surface suction mode to the side surface suction mode, the movable part 310 moves away from the base part 306. Consequently, the base part 306 is pulled by the movable part 310 to rotate about the rotary axis 305 to effect a change from an orientation depicted in FIG. 3A to an orientation depicted in FIG. 4A. In contrast, to switch from the side surface suction mode to the upper-surface suction mode, the movable part 310 moves closer to the base part 306. Thus, the base part 306 is pushed by the movable part 310 to rotate about the rotary axis 305 to effect a change from an orientation depicted in FIG. 4A to an orientation depicted in FIG. 3A. A drive mechanism which rotationally drives the base part 306 with respect to the base part 302 is formed by a combination of the passive rotary joint 304, the movable part 310, the passive rotary joint 312, the link member 314, the passive rotary joint 316, and a driver 812 described below (FIG. 8).

The active linear motion mechanism 318 is fixed to the base part 302, for example, to the upper surface 303 of the base part 302. The active linear motion mechanism 318 linearly moves the rod member 320 serving as a protruding member. Specifically, the active linear motion mechanism 318 moves the rod member 320 in a direction which crosses the rotary axis 305. In the upper-surface suction mode, the rod member 320 is pulled inward by the active linear motion mechanism 318 as depicted in FIG. 3A. In the side surface suction mode, when pushed out by the active linear motion mechanism 318, the rod member 320 protrudes outward through a gap between the base part 302 and the base part 306 as depicted in FIG. 4A. The passive rollers 322 may be arranged at a tip portion of the rod member 320. The passive rollers 322 rotate upon coming into contact with the article. When the passive rollers 322 are provided at the tip portion of the rod member 320, the article can be prevented from being damaged by a pressing force when the tip of the rod member 320 comes into contact with the article. Each of the passive rollers 322 may be provided with a one-way clutch which regulates a rotating direction. In this case, when the article is going to slip off the passive rollers 322 due to the weight of the article, the passive rollers 322 are prevented from rotating.

When the side surface of the article is held, a moment resulting from the weight of the article acts on the vacuum suction pads 308. This makes the article fall off the vacuum suction pads 308 easily. Thus, in the present embodiment, when the article is carried in the side surface suction mode, the passive rollers 322 are brought into contact with the article. When the passive rollers 322 are brought into contact with the article, a moment can be generated which reduces or cancels a moment resulting from the weight of the article. As a result, the article is prevented from falling off the vacuum suction pads 308.

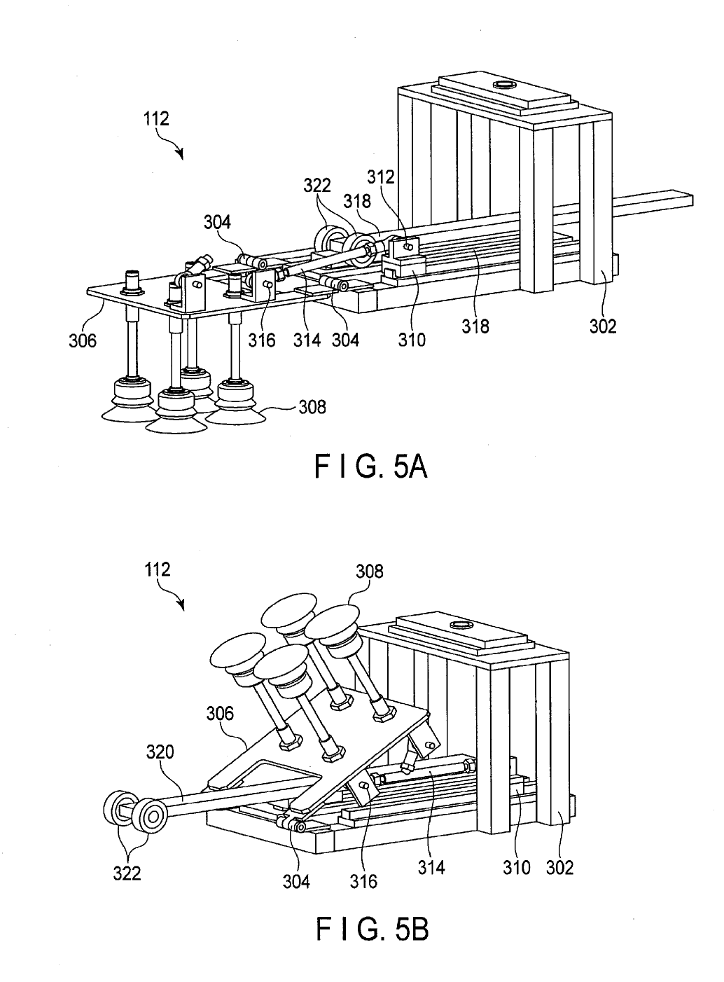

FIG. 5A is a perspective view depicting the holding device 112 in the upper-surface suction mode. FIG. 5B is a perspective view depicting the orientation in which the holding device 112 carries the article in the side surface suction mode. In the example illustrated in FIG. 5A and FIG. 5B, four vacuum suction pads 308 are arranged on the base part 306. As depicted in FIG. 5B, when the holding device 112 carries the article in the side surface suction mode, the base part 306 tilts to the base part 302 side with respect to the vertical direction. Consequently, a part of the weight of the article acts on the vacuum suction pad 308 side, improving stability during carriage.

FIG. 5A and FIG. 5B illustrate an example where the movable part 310 is a linear slider. To adjust the amount of inclination of the base part 306, a moving distance of the movable part 310 is desirably continuously variable. The moving distance of the movable part 310 may be variable on a step-by-step basis. The movable part 310 is not limited to the linear slider and may be a configuration with a combination of an electric motor and a rack pinion, a configuration with a pneumatic cylinder, or the like. The active linear motion mechanism 318 may be, for example, a linear slider, a configuration with a combination of an electric motor and a rack pinion, or a configuration with a pneumatic cylinder.

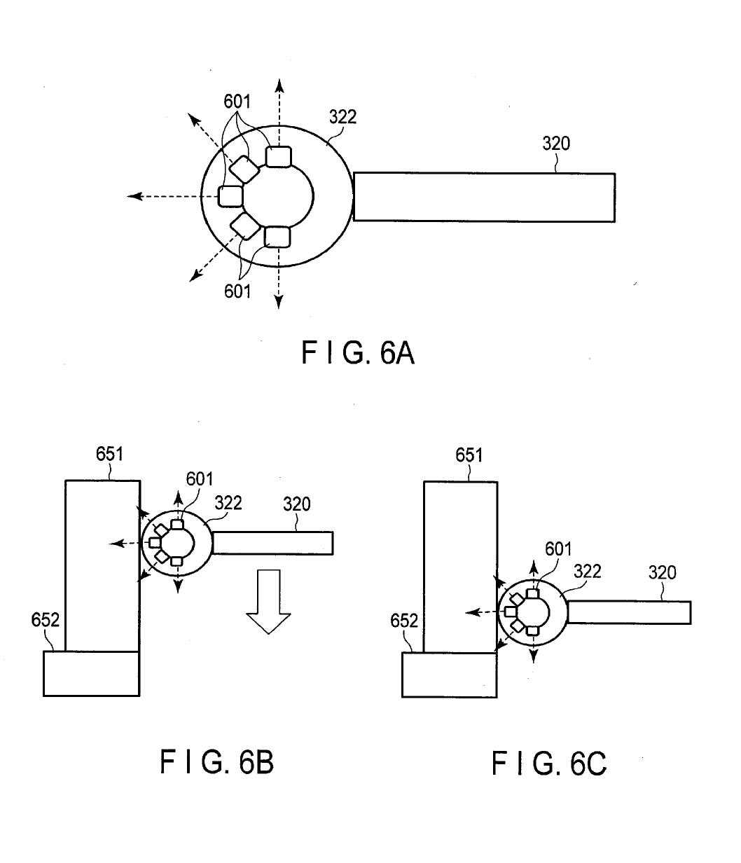

The tip portion (for example, the passive rollers 322) of the rod member 320 may be provided with a sensor which senses the surface of the article. FIG. 6A illustrates an example in which one or more (for example, five) range sensors 601 are provided on a shaft part of the passive rollers 322. The range sensors 601 are arranged at regular intervals in a circumferential direction. In this case, distances are radially measured. As the range sensors 601, for example, fiber sensors, laser displacement sensors, or ultrasonic sensors may be used. Any other sensor may be used which outputs a voltage or a current corresponding to a distance. As depicted in FIG. 6B, an article 651 is placed on an article 652. As depicted in FIG. 6C, the rod member 320 moves downward along the side surface of the article 651. In the meantime, a process is executed in which a boundary (seam) between the article 651 and the article 652 is detected using the range sensors 601. A position where the passive rollers 322 contact the article is desirably lower than the position of the center of gravity of the article. This is needed to effectively reduce or cancel the moment resulting from the weight of the article 652. Detecting the boundary between the article 651 and the article 652 enables the passive rollers 322 to push a lower end of the article 651. As a result, stability during carriage of the article is improved.

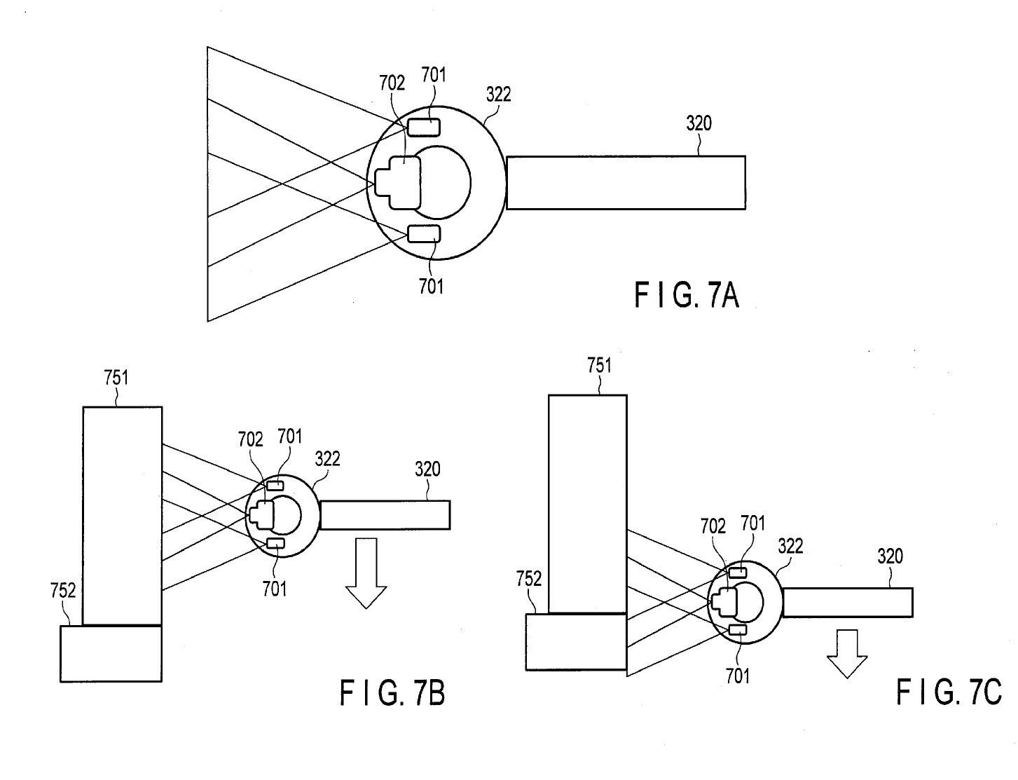

FIG. 7A illustrates an example where one or more (for example, two) illuminating devices 701 and at least one (for example, one) image sensor 702 are provided on the shaft part of the passive rollers 322. The illuminating devices 701 and the image sensor 702 are arranged so as to face a moving direction of the rod member 320. A lens used for the image sensor 702 may be an ordinary lens, a wide-angle lens, or a fish eye lens. The illuminating devices 701 emit light toward the article. Consequently, the boundary between the articles can be clearly shaded. The image sensor 702 images the article illuminated by the illuminating devices 701. As depicted in FIG. 7B, the article 751 is placed on the article 752. The rod member 320 moves downward along the side surface of the article 751. In the meantime, the image sensor 702 obtains an image. As depicted in FIG. 7C, the boundary between the article 751 and the article 752 is detected in the image obtained by the image sensor 702.

FIG. 8 depicts a control system for the holding device 112. The control system depicted in FIG. 8 includes a rotational angle detector 802, a moving distance detector 804, a contact detector 806, a moving distance detector 814, a controller 808, a driver 810, and a driver 812. The controller 808 is included in the robot controller 120 depicted in FIG. 1.

The controller 808 controls the driver 810 and the driver 812. Specifically, the controller 808 generates a command including a moving distance of the movable part 310, and provides the command to the driver 812. The driver 812 moves the movable part 310 in accordance with the command from the controller 808. The controller 808 generates a command including a moving distance of the rod member 320 and provides the command to the driver 810. The driver 810 includes the active linear motion mechanism 318 and moves the rod member 320 in accordance with the command from the controller 808.

The rotational angle detector 802 detects a rotational angle of the passive rotary joint 304 to output information indicative of the detected rotational angle. The moving distance detector 804 detects the moving distance of the rod member 320 to output information indicative of the detected moving distance. The contact detector 806 detects that the passive rollers 322 have come into contact with any object (for example, an article) to output information indicating that the passive rollers 322 have come into contact with the object. The moving distance detector 814 detects the moving distance of the movable part 310 to output information indicative of the detected moving distance. The controller 808 is provided with the information output from the rotational angle detector 802, the moving distance detector 804, the contact detector 806, and the moving distance detector 814. Thus, the moving distance of the movable part 310 and the moving distance of the rod member 320 are fed back to the controller 808. The controller 808 adjusts the moving distance of the movable part 310 based on the information output from the rotational angle detector 802 and the moving distance detector 814. The controller 808 adjusts the moving distance of the rod member 320 based on the information output from the moving distance detector 804 and the contact detector 806.

Now, operations of the robot handling system 100 will be described.

With reference to FIG. 1, an operating procedure will be described in brief. First, upon completing preparations for acceptance of the article from the automatic conveyor 161, the conveyor controller 162 transmits a three-dimensional position measurement request signal to the calculator 132 of the recognizing device 130. Upon receiving the three-dimensional position measurement request signal from the conveyor controller 162, the calculator 132 starts three-dimensional position measurement. The calculator 132 uses the distance image sensor 131 to measure three-dimensional position information on the article 151. If an inclined article 151 is detected, the calculator 132 transmits an error detection signal to the conveyor controller 162. If no inverted article 151 is detected, the calculator 132 the three-dimensional position information to the robot controller 120.

Upon receiving the three-dimensional position information from the calculator 132, the robot controller 120 determines a procedure for taking out the article 151 which can be transferred by the transfer device 110, based on the three-dimensional position information. The robot controller 120 operates the holding device 112 of the transfer device 110 to transfer the article 151 from the cage cart 150 onto the automatic conveyor 161. Once all of the transfer is completed, the robot controller 120 transmits a transfer completion signal to the three-dimensional position recognizing device 130. The three-dimensional position recognizing device 130 performs the three-dimensional position measurement again in order to check whether any of the articles 151 remains on the cage cart 150. If any of the articles 151 remains, the calculator 132 transmits the three-dimensional position information to the robot controller 120 to allow the article 151 to be transferred. If none of the articles 151 remains, the calculator 132 transmits the transfer completion signal to the conveyor controller 162. Upon receiving the transfer completion signal, the conveyor controller 162 notifies an operator or the like of the reception. The operator or the like moves the cage cart 150 with no article remaining thereon and supplies the next cage cart. In the present embodiment, the holding device 112 of the transfer device 110 transfers the articles in order starting with the articles in the uppermost stage, which are easy to handle. The position information from the three-dimensional position recognizing device 130 enables determination of the order in which the articles are taken out.

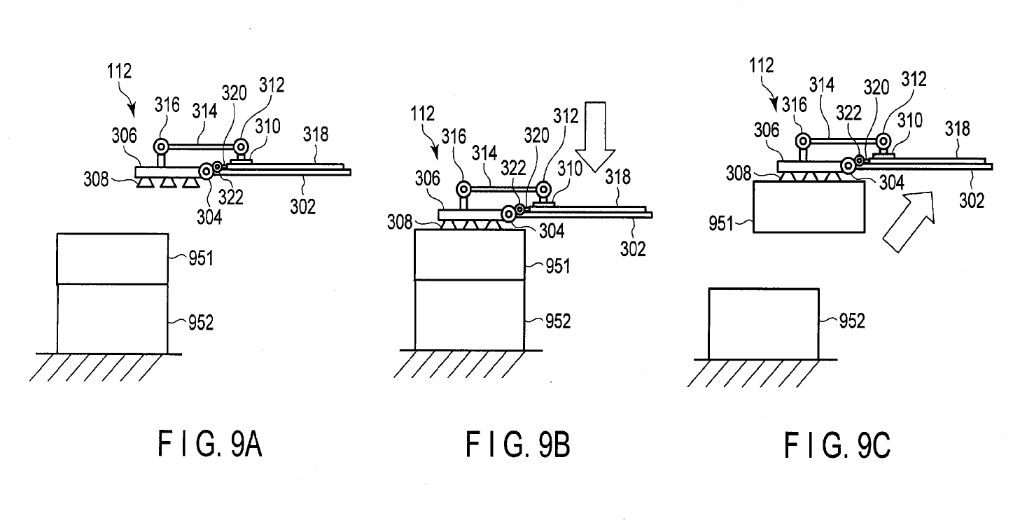

With reference to FIGS. 9A to 9C, an example operation of the holding device 112 in the upper-surface suction mode will be described. As depicted in FIG. 9A, an article 951 is placed on an article 952. Upon determining that an upper surface of the article 951 can be sucked and held, the robot controller 120 controls the transfer device 110 as described below. The holding device 112 moves forward while remaining at a position which is higher than the upper surface of the article 951. As depicted in FIG. 9B, the holding device 112 moves forward to a position opposite to the upper surface of the article 951 and subsequently moves downward. The holding device 112 moves downward until the vacuum suction pads 308 come into contact with the upper surface of the article 951. Then, the vacuum pump evacuates the vacuum suction pads 308 to allow the article 951 to be held by the vacuum suction pads 308. As depicted in FIG. 9C, the holding device 112 moves upward and rearward to carry the article 951.

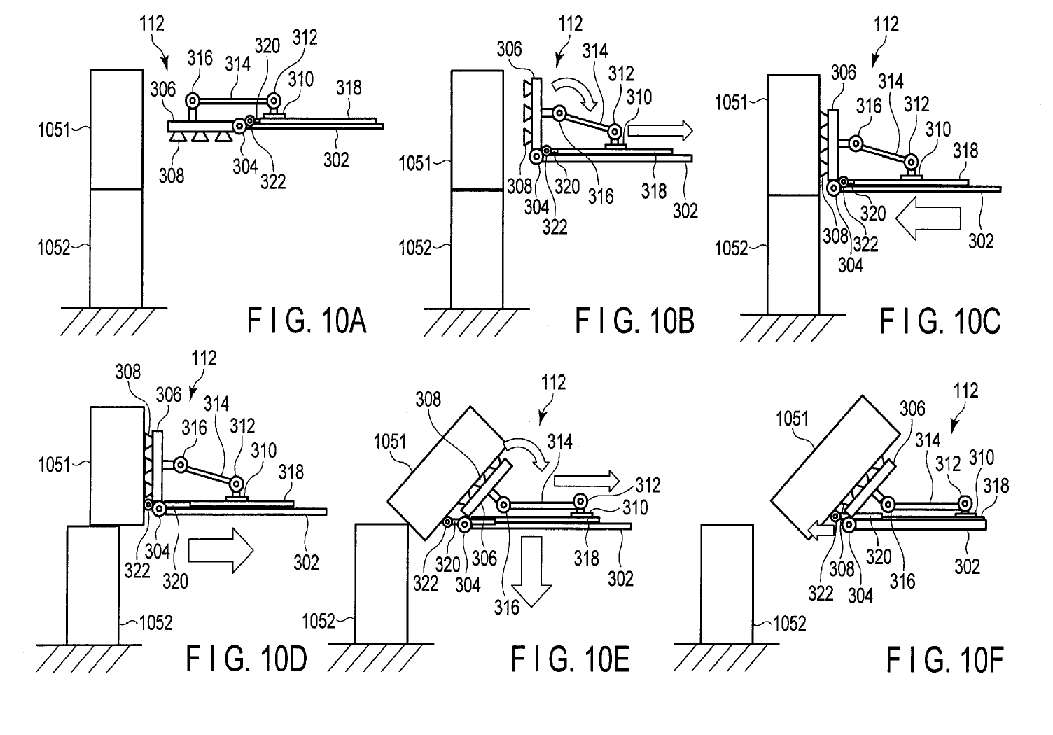

With reference to FIGS. 10A to 12F, examples of the operation of the holding device 112 in the side surface suction mode will be described.

FIGS. 10A to 10F illustrate an example where the article 951 is carried with the holding device 112 tilted from the vertical direction to the base part 302 side. As depicted in FIG. 10A, an article 1051 is placed on an article 1052. Upon determining that sucking and holding a side surface of the article 1051 is more preferable, the robot controller 120 controls the transfer device 110 as described below. The holding device 112 moves toward the side surface of the article 1051. As depicted in FIG. 10B, the holding device 112 changes the orientation of the base part 306 to the vertical direction so that the vacuum suction pads 308 lie opposite to the side surface of the article 1051. When a lower end of the article 1051 can be detected utilizing the sensor provided on the three-dimensional position recognizing device 130 or the passive rollers 322, the holding device 112 moves downward to a position where the passive rollers 322 lie opposite to the lower end of the article 1051.

As depicted in FIG. 10C, the holding device 112 moves forward until the vacuum suction pads 308 come into contact with the side surface of the article 1051. Then, the vacuum pump evacuates the vacuum suction pads 308 to allow the article 1051 to be held by the vacuum suction pads 308. Determination of whether or not the article 1051 has been successfully held may be based on, for example, the amount of change in a pressure sensor or a flow rate sensor mounted in a solenoid valve connected to each of the vacuum suction pads 308 via a tube or the amount of deformation of the vacuum suction pad 308 measured by image diagnosis. Then, as depicted in FIG. 10D, the active linear motion mechanism 318 drives the rod member 320 to bring the passive rollers 322 into contact with the article 1051. The holding device 112 moves slightly rearward. As depicted in FIG. 10E, while pushing the rod member 320 to the article 1051 side, the holding device 112 changes the orientation of the base part 306 so as to tilt the base part 306 to the base part 302 side. That is, the article 1051 is tilted to the base part 302 side utilizing a pressing force of the rod member 320 and a turning force of the base part 306. At this time, the turning force of the base part 306 is generated by driving of the movable part 310. The base part 306 may, for example, rotate passively or elastically passively utilizing the pressing force of the rod member 320. At this time, the holding device 112 may move downward according to the amount of tilt of the article 1051. Then, as depicted in FIG. 10F, the holding device 112 moves rearward to carry the article 1051.

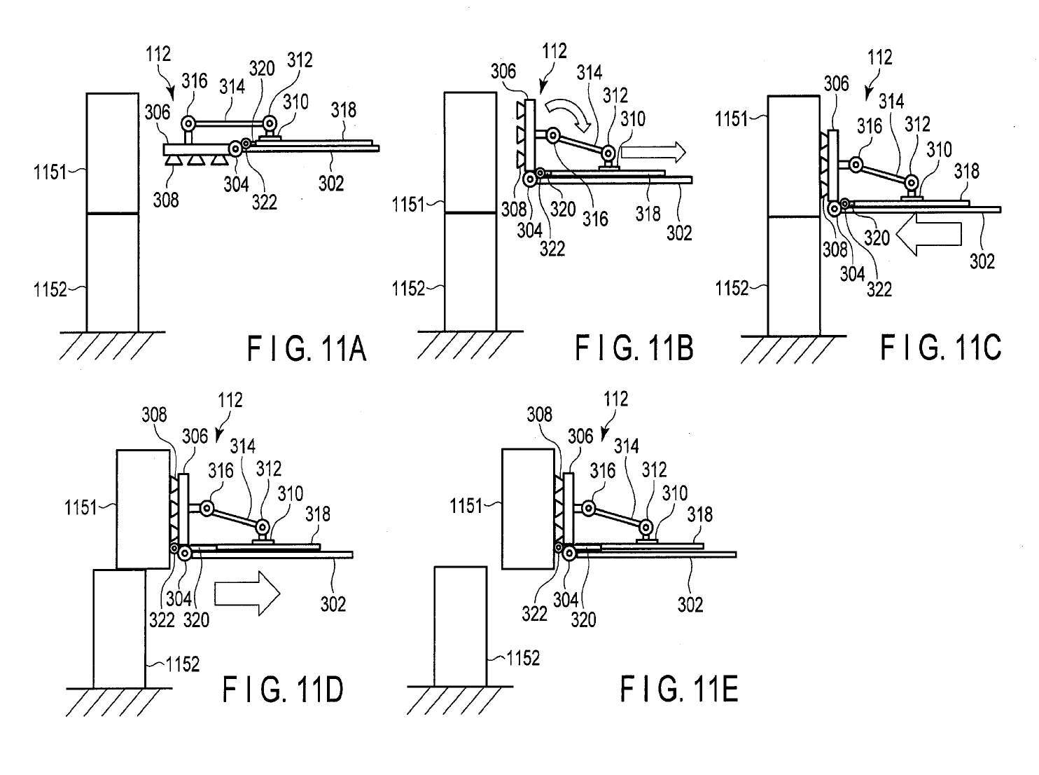

FIGS. 11A to 11E illustrate an example in which the article is carried with the orientation of the holding device 112 kept in the vertical direction. As depicted in FIG. 11A, an article 1151 is placed on an article 1152. Upon determining that sucking and holding a side surface of the article 1151 is more preferable and further determining that tilting of the article 1151 needs to be avoided or receiving an indication of the avoidance, the robot controller 120 controls the transfer device 110 as described below. A procedure illustrated in FIG. 11A, FIG. 11B, FIG. 11C, and FIG. 11D is the same as the procedure described with reference to FIG. 10A, FIG. 10B, FIG. 10C, and FIG. 10D, and thus, description of this procedure is omitted. As depicted in FIG. 11E, with the vacuum suction pads 308 sucking and holding the article 1151 and with the passive rollers 322 in contact with the article 1151, the holding device 112 moves rearward to carry the article 1151.

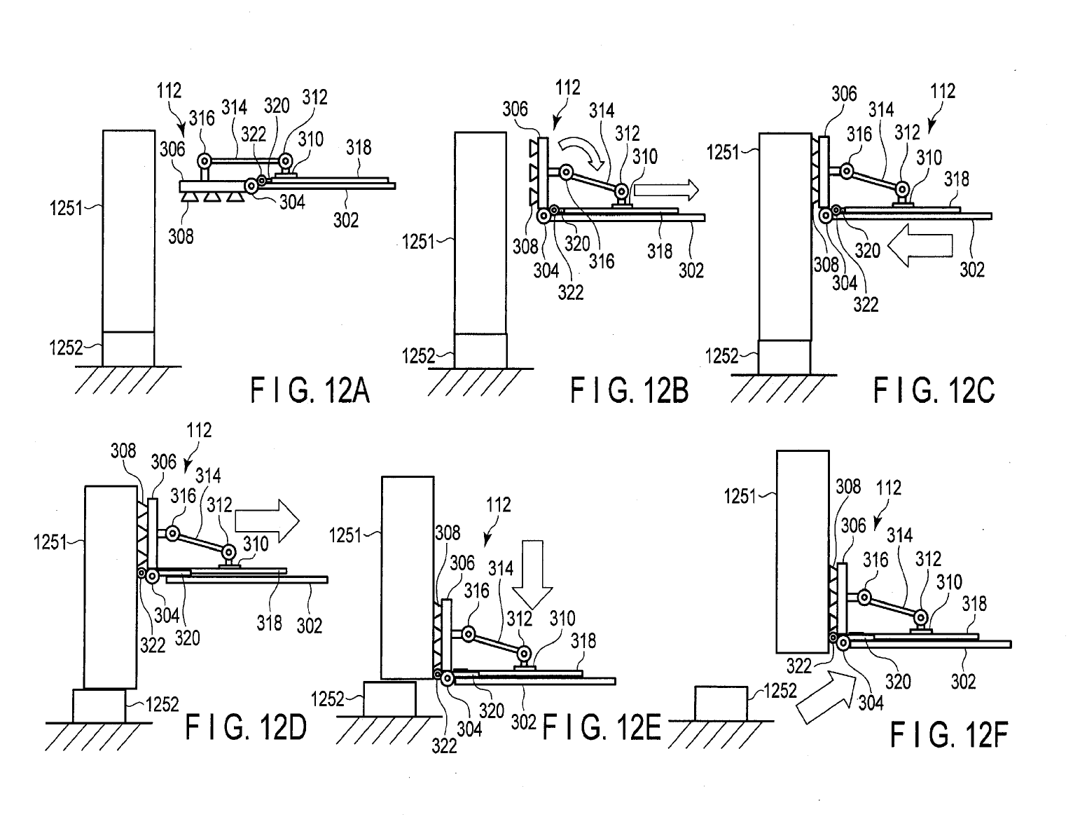

FIGS. 12A to 12F illustrate an example where an article is carried with the orientation of the holding device 112 kept in the vertical direction. As depicted in FIG. 12A, an article 1251 is placed on an article 1252. In this example, the article 1251 is elongate in the vertical direction. In this case, the robot controller 120 controls the transfer device 110 as described below. The holding device 112 moves toward a side surface of the article 1251. As depicted in FIG. 12B, the holding device 112 changes the orientation of the base part 306 to the vertical direction so that the vacuum suction pads 308 lie opposite to the side surface of the article 1251. As depicted in FIG. 12C, the holding device 112 approaches the article 1251. As depicted in FIG. 12D, the holding device 112 moves forward until the vacuum suction pads 308 come into contact with the side surface of the article 1251. The vacuum suction pads 308 suck and hold the article 1251. Subsequently, the holding device 112 moves slightly rearward to move the article 1251. Consequently, the article 1251 is drawn to the holding device 112 side to allow a lower end of the article 1251 to be easily detected. The active linear motion mechanism 318 drives the rod member 320 to allow the passive rollers 322 to approach the article 1251. As depicted in FIG. 12E, the holding device 112 moves downward while searching for the lower end of the article 1251 utilizing the sensor provided on the passive rollers 322. When the lower end of the article 1251 is detected, the holding device 112 is stopped at a position where the passive rollers 322 lie opposite to the lower end of the article 1251. The holding device 112 moves forward until the vacuum suction pads 308 come into contact with the side surface of the article 1251. The vacuum pump evacuates the vacuum suction pads 308, which thus suck and hold the article 1251. As depicted in FIG. 12F, the holding device 112 carries the article 1251.

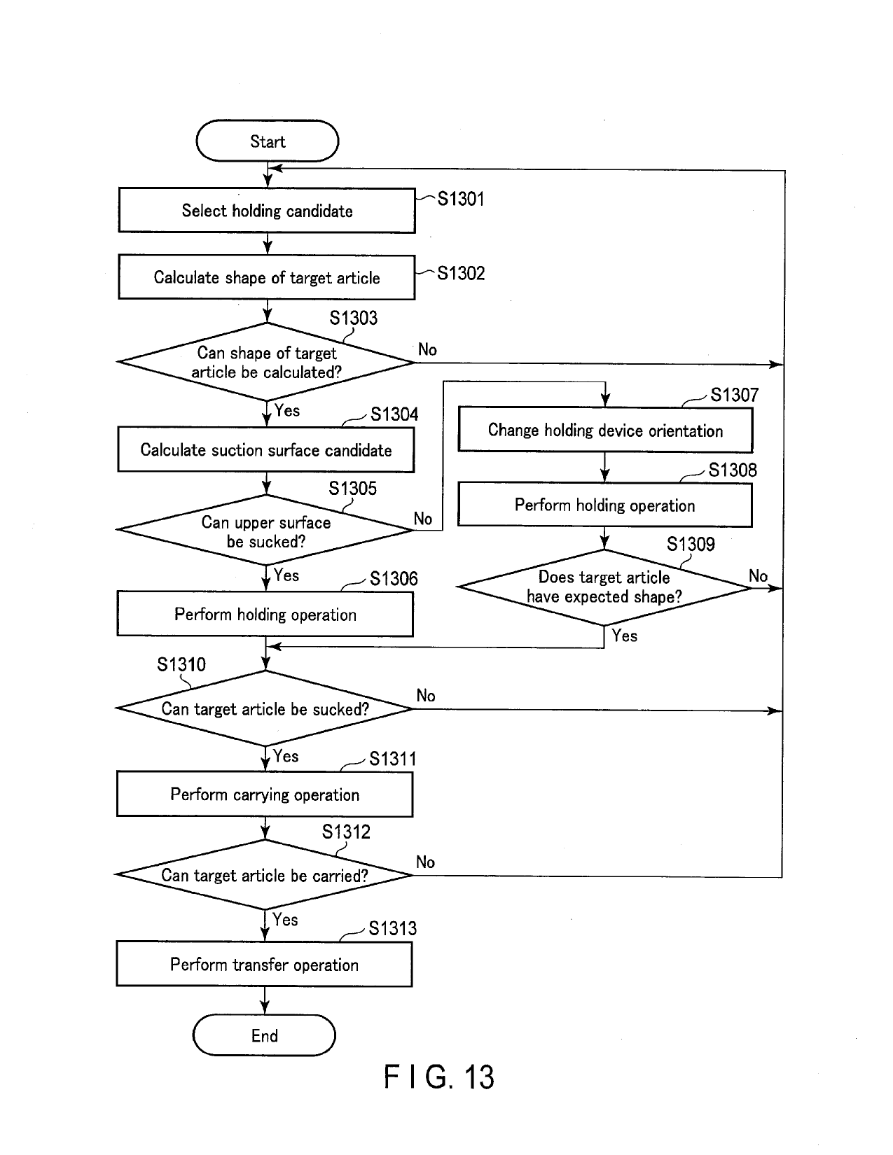

FIG. 13 illustrates an example procedure of a transfer process according to the present embodiment. In step S1301 in FIG. 13, the robot controller 120 selects an article which can be sucked and held based on the three-dimensional position information from the three-dimensional position recognizing device 130. The selected article is referred to as a target article. In step S1302, the robot controller 120 calculates the shape of the target article. If the shape of the target article is not allowed to be calculated, the robot controller 120 shifts from step S1303 back to step S1301 to select another article.

If the shape of the target article is calculated, the robot controller 120 proceeds from step S1303 to step S1304. In step S1304, the robot controller 120 determines a candidate surface which can be sucked and held by executing relevant calculation for each of the surfaces of the target article. In step S1305, the robot controller 120 determines whether or not an upper surface of the target article can be sucked. If the upper surface of the target article can be sucked, the robot controller 120 proceeds to step S1306, where an operation of holding the target article is performed.

If the upper surface of the target article is not allowed to be sucked, the robot controller 120 proceeds to step S1307. In step S1307, the robot controller 120 changes the orientation of the holding device 112. For example, the holding device 112 is switched to the side surface suction mode as depicted in FIG. 4A. In step S1308, an operation of holding the target article is performed. In step S1309, the robot controller 120 determines whether or not the target article has an expected shape. The robot controller 120 proceeds to step S1310 if the target article has the expected shape, and otherwise returns to step S1301.

In step S1310, the robot controller 120 determines whether or not the target article can be sucked and held. Upon determining that the target article is not allowed to be sucked or held, the robot controller 120 returns to step S1301. Upon determining that the target article can be sucked and held, the robot controller 120 proceeds to step S1311, where an operation of carrying the target article is performed. In step S1312, the robot controller 120 determines whether or not the target article can be carried. Upon determining that the target article is not allowed to be carried, the robot controller 120 returns to step S1301. Upon determining that the target article can be carried, the robot controller 120 proceeds to step S1313, where the target article is carried and loaded onto the automatic conveyor.

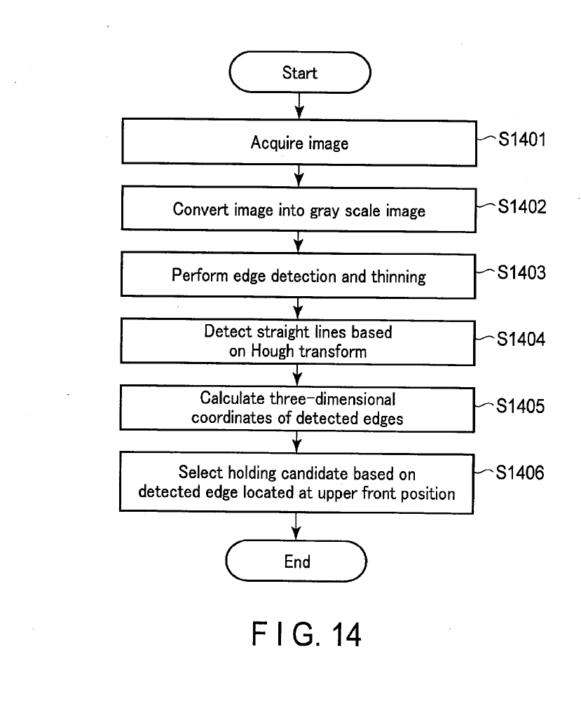

FIG. 14 illustrates a specific example of the processing in step S1301. In step S1401 in FIG. 14, the robot controller 120 acquires an image of the articles loaded in the cage cart. In step S1402, the robot controller 120 converts the acquired image into a gray scale image. In step S1403, the robot controller 120 performs edge detection and thinning on the image. In step S1404, the robot controller 120 executes Hough transform on the image to detect straight lines in the image as edges. In step S1405, the robot controller 120 calculates the three-dimensional coordinates of the detected edges. In step S1406, the robot controller 120 selects an article with an edge located above and in front of the holding device 112.

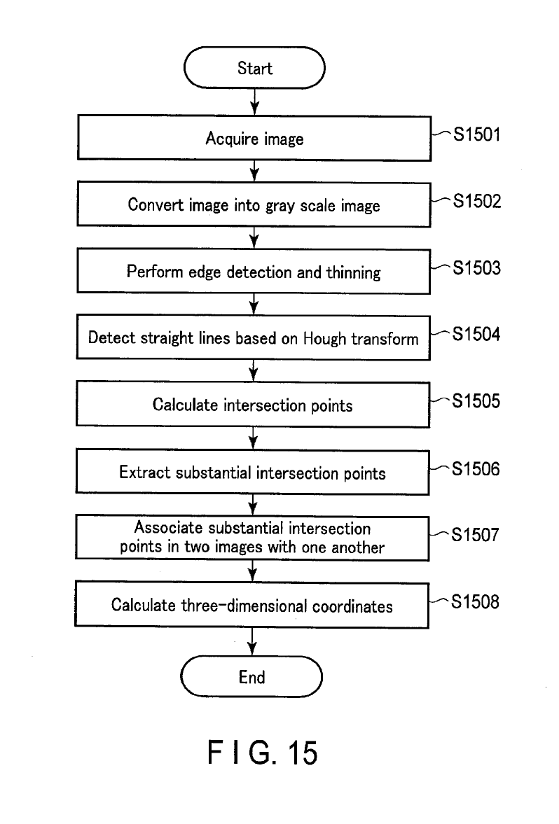

FIG. 15 illustrates a specific example of the processing in step S1302 in FIG. 13. In this example, the three-dimensional position of the article is calculated based on two images obtained by moving the image sensor slightly. Processing in steps S1501 to S1506 in FIG. 15 is executed on each of the images. The processing in steps S1501 to S1504 in FIG. 15 are similar to the processing described for steps S1401 to S1404, and thus, description of these steps is omitted. In step S1505, the robot controller 120 calculates intersection points of edges detected in step S1504. In step S1506, the robot controller 120 extracts substantial intersection points (which actually correspond to vertices of the article) from all the intersection points. In step S1507, the robot controller 120 associates the substantial intersection points in the two images with one another. In step S1508, the robot controller 120 calculates the three-dimensional coordinates of the vertices of the article by using the stereo method.

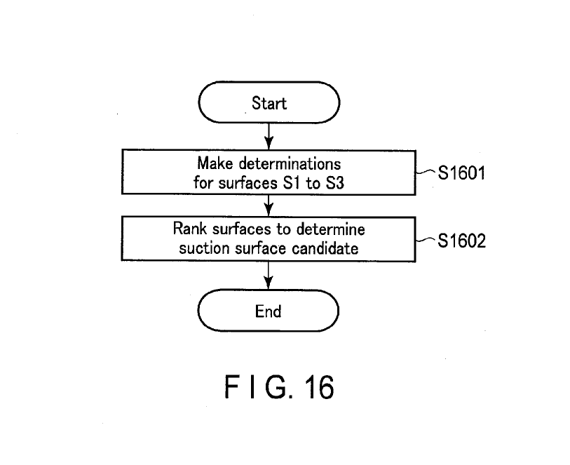

FIG. 16 illustrates a specific example of the processing in step S1304 in FIG. 13. This example uses images obtained by the distance image sensors 131 depicted in FIG. 1. A side surface of the article which lies opposite to the holding device 112 is referred to as a surface S1. An upper surface of the article is referred to as a surface S2. A side surface having sides shared by the surface S1 and the surface S2 are referred to as S3. In step S1601 in FIG. 16, the robot controller 120 determines whether each of the surfaces S1, S2, S3 of the target article can be held based on a template matching image. In step S1602, the robot controller 120 ranks the surfaces S1, S2, S3 to determine a suction surface candidate.

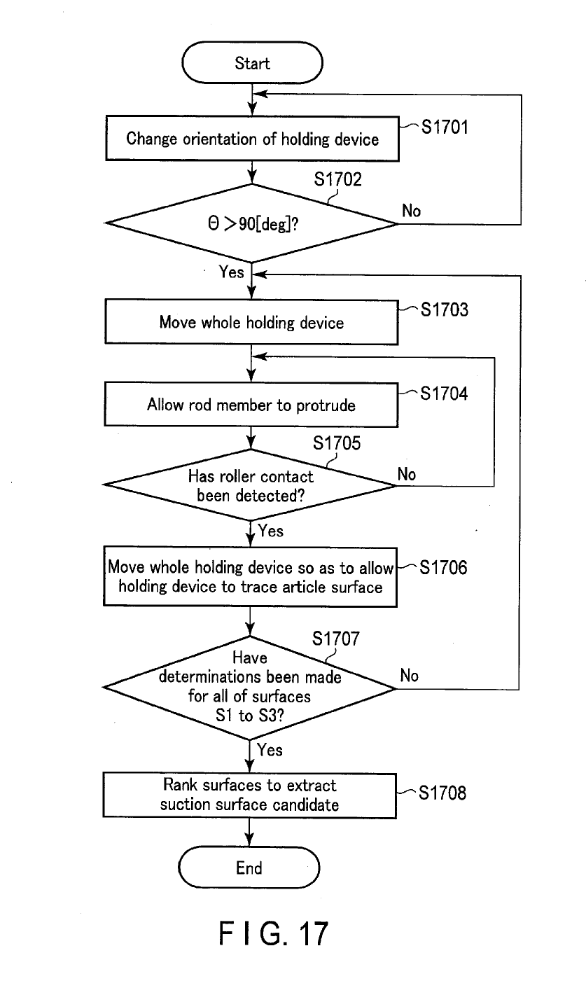

FIG. 17 illustrates another specific example of the processing in step S1304 in FIG. 13. This example uses the sensor provided at the tip portion of the rod member 320. In step S1701 in FIG. 17, the robot controller 120 changes the orientation of the holding device 112. Specifically, the robot controller 120 moves the movable part 310 in order to rotate the base part 306. The robot controller 120 moves the movable part 310 until the base part 306 is placed at an angle θ of 90 degrees (step S1702). In this case, the angle θ is indicative of the angle of the base part 306 based on the position of the base part 306 in the upper-surface suction mode. As a result, the holding device 112 changes from the orientation depicted in FIG. 3A to the orientation depicted in FIG. 4A.

In step S1703, the robot controller 120 moves the holding device 112. In step S1704, the robot controller 120 allows the rod member 320 to protrude. The robot controller 120 allows the rod member 320 to protrude until the passive rollers 322 come into contact with the target article (step S1705). In step S1706, the robot controller 120 moves the holding device 112 so as to allow the passive rollers 322 to trace the surface of the target article. The robot controller 120 executes the processing in steps S1703 to S1706 on each of the surfaces S1, S2, S3 to determine whether each of the surfaces S1, S2, S3 can be held (step S1706). In step S1707, the robot controller 120 ranks the surfaces S1, S2, S3. When the surfaces S1, S2, S3 can be ranked by image recognition using the three-dimensional position recognizing device 130, the operation in which the passive rollers 322 move while tracing the surface of the article is not necessarily needed.

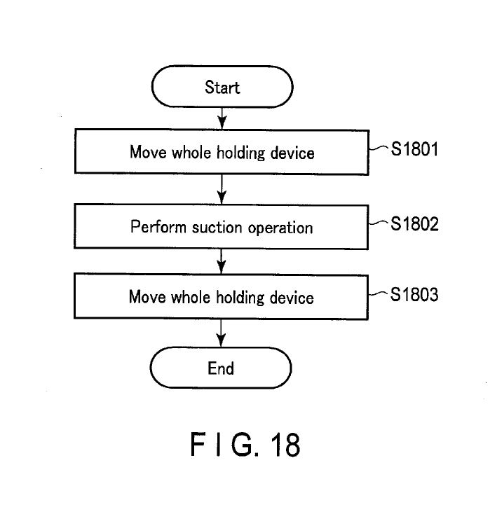

FIG. 18 illustrates a specific example of the processing in step S1306 in FIG. 13. The processing in step S1306 in FIG. 13 is an operation in which the holding device 112 holds the article in the upper-surface suction mode. In step S1801, the robot controller 120 moves the holding device 112 toward the upper surface of the target article. In step S1802, the robot controller 120 evacuates the vacuum suction pads 308 in order to suck and hold the target article. In step S1803, the robot controller 120 moves the holding device so as to lift the target article by a predetermined moving distance.

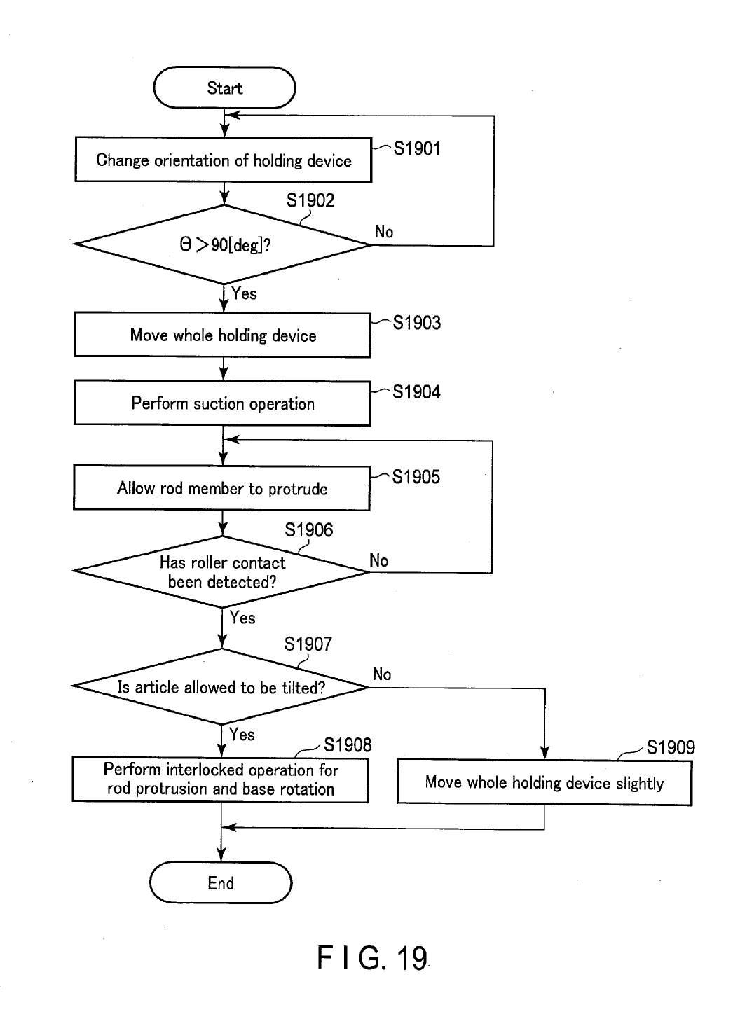

FIG. 19 illustrates a specific example of the processing in steps S1307 and S1308 in FIG. 13. In step S1901 in FIG. 19, the robot controller 120 changes the orientation of the holding device 112. The robot controller 120 moves the movable part 310 in order to rotate the base part 306. The robot controller 120 moves the movable part 310 until the base part 306 is placed at an angle θ of 90 degrees (step S1702). As a result, the holding device 112 changes from the orientation depicted in FIG. 3A to the orientation depicted in FIG. 4A.

In step S1903, the robot controller 120 moves the holding device 112 such that the vacuum suction pads 308 of the holding device 112 come into contact with the side surface of the article. In step S1904, the robot controller 120 evacuates the vacuum suction pads 308 in order to suck and hold the target article. In step S1905, the robot controller 120 pushes the rod member 320 outward. The robot controller 120 pushes out the rod member 320 until the passive rollers 322 come into contact with target article (step S1906). In step S1907, the robot controller 120 determines whether or not the article can be tilted. Upon determining that the article can be tilted, the robot controller 120 proceeds to step S1908 to perform an operation of pressing the rod member 320 and an operation of rotating the base part 306. The robot controller 120 thus obliquely holds the article. Upon determining that the article is not allowed to be tilted, the robot controller 120 proceeds to step S1909 to move the holding device 112 by a predetermined moving distance.

As described above, the variable article holding device 112 according to the first embodiment includes the base part 306, the vacuum suction pads 308 which is provided on the base part 306 and holds the article, the base part 302 which supports the base part 306 such that the base part 306 can rotate around the rotary axis 305, and the driving mechanism which rotationally drives the base part 306. Changing the orientation of the base part 306 allows the upper surface or side surface of the article to be selectively held. The variable article holding device 112 further includes the rod member 320 and the active linear motion mechanism 318 which is provided on the base part 302 and moves the rod member 320 in a direction crossing the rotary axis. If the side surface of the article is held, the rod member 320 is pressed against the article. This allows generation of such a moment as cancels a moment resulting from the weight of the article. As a result, the article can be prevented from falling off the vacuum suction pads 308.

### Modifications of the First Embodiment

Modifications of the first embodiment will be described. In each modification, the same components as those which are depicted in FIG. 3 will not be described below.

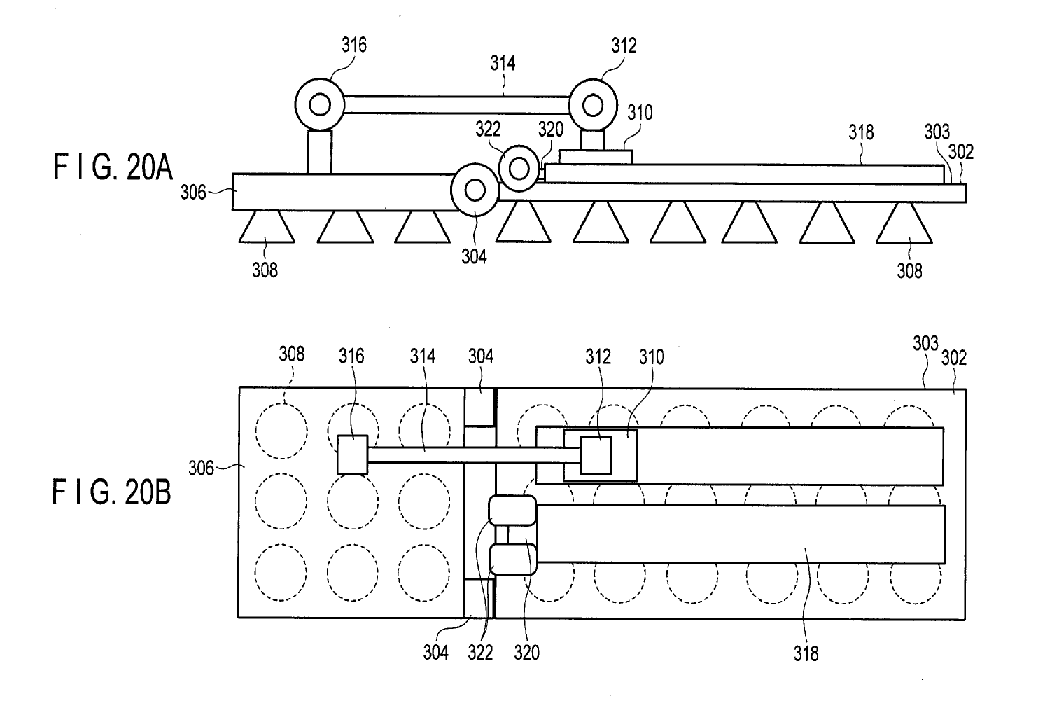

FIG. 20A and FIG. 20B are a side view and a top view schematically illustrating a modification of the holding device according to the first embodiment. In the holding device depicted in FIG. 20A and FIG. 20B, one or more vacuum suction pads 308 are provided not only on the base part 306 but also on the base part 302; for example, 18 vacuum suction pads 308 are provided on the base part 302. Consequently, the article can be sucked and held utilizing not only the base part 306 but also the base part 302, enhancing safety in holding of the article in the upper-surface suction mode. Moreover, facility costs can be suppressed, enabling space saving.

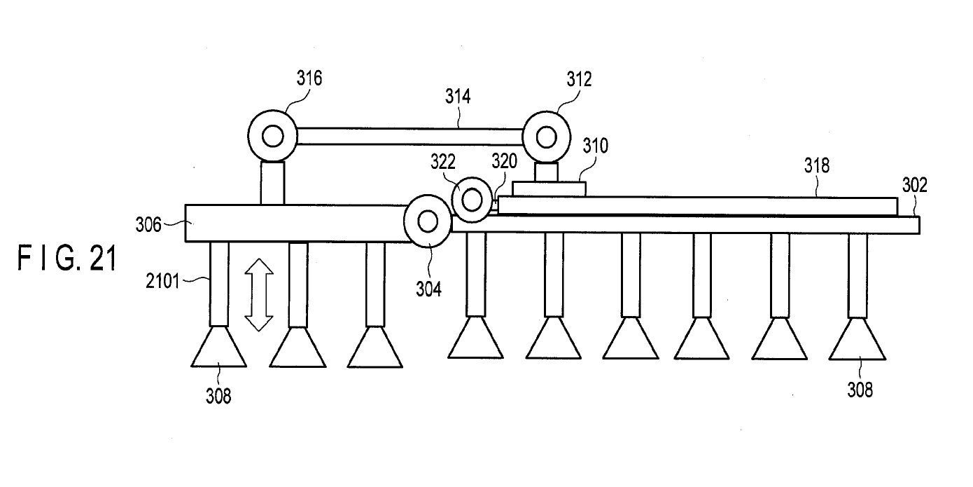

FIG. 21 is a side view schematically depicting another modification of the holding device according to the first embodiment. In the holding device depicted in FIG. 21, each of the vacuum suction pads 308 includes a support 2101 which can move elastically passively and linearly. Consequently, even if the holding device is less accurately positioned by the manipulator, the amount of positioning error can be mechanically absorbed.

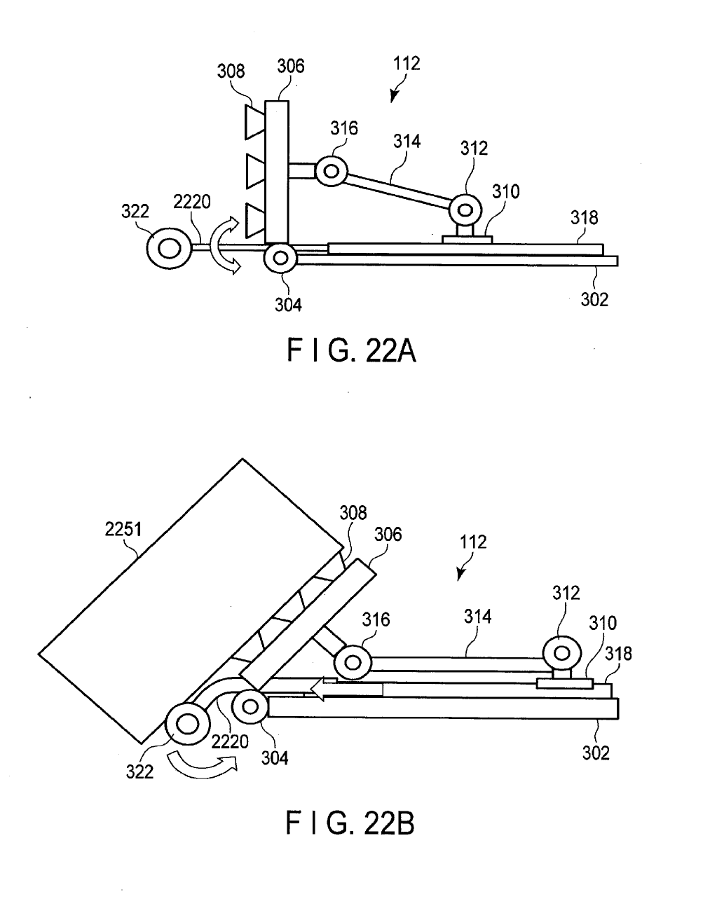

FIG. 22A is a side view schematically depicting yet another modification of the holding device according to the first embodiment. The holding device depicted in FIG. 22A includes an elastic rod member 2220 instead of the rod member 320. The rod member 2220 can be elastically deformed under an external force as depicted by an arrow. As depicted in FIG. 22B, when the passive rollers 322 are pressed against an article 2251, the rod member 2220 is elastically deformed such that the positions of the passive rollers 322 vary in conformity with the shape of a side surface of the article 2251. Thus, the article can be stably held without any special control. Moreover, an elastic force of the rod member 2220 allows exertion of a force which rotates the article upward. Consequently, the article can be more stably held.

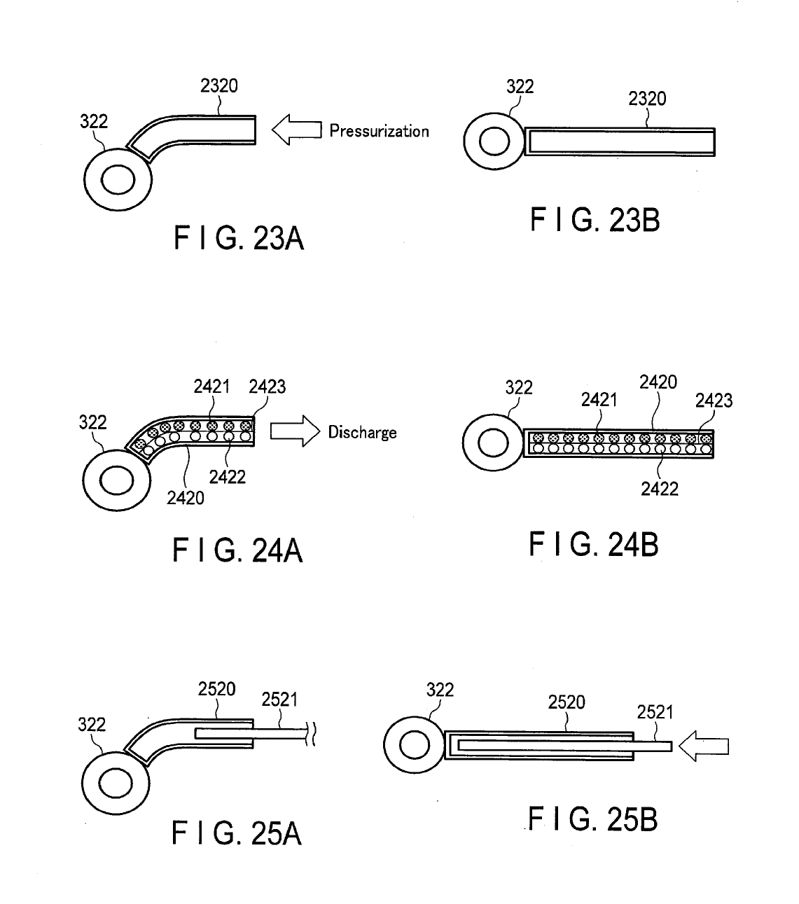

FIG. 23A is a side view schematically depicting still another modification of the holding device according to the first embodiment. In the modification depicted in FIG. 23A, a rod member 2320 is used which includes a hollow main body made of an elastic material. As depicted in FIG. 23B, the inside of the main body is pneumatically pressurized to expand the rod member 2320, leading to an increased rigidity of the rod member 2320. The elastic material may be any material which can resist the pressurization, for example, rubber or silicone. The elastic force of the rod member 2320 can be adjusted by the applied pressure.

FIG. 24A is a side view schematically depicting a further modification of the holding device according to the first embodiment. The modification depicted in FIG. 24A uses a rod member 2420 the rigidity of which can be varied utilizing jamming transition. The rod member 2420 includes a hollow main body made of an elastic material. An internal space in the main body is separated into two air chambers by a partition 2423. One of the air chambers is filled with particles 2421 each with a small particle size, while the other air chamber is filled with particles 2422 each with a large particle size. As depicted in FIG. 24B, when air is discharged from the internal space in the main body, a bending operation results from the difference in particle size. The air discharge increases the rigidity of the rod member 2420, resulting in no likelihood of burst of the rod member 320 or the like.

FIG. 25A is a side view schematically depicting further another modification of the holding device according to the first embodiment. The modification depicted in FIG. 25A uses a rod member 2520 including a hollow main body made of an elastic material and a cylindrical bar 2521. The rigidity of the rod member 2520 is increased by inserting the cylindrical bar 2521 into the main body. Specifically, as depicted in FIG. 25B, the rod member 2520 is made rigid by inserting the cylindrical bar 2521 into the main body. The rigidity of the rod member 2520 can be mechanically increased without utilization of pneumatic pressure.

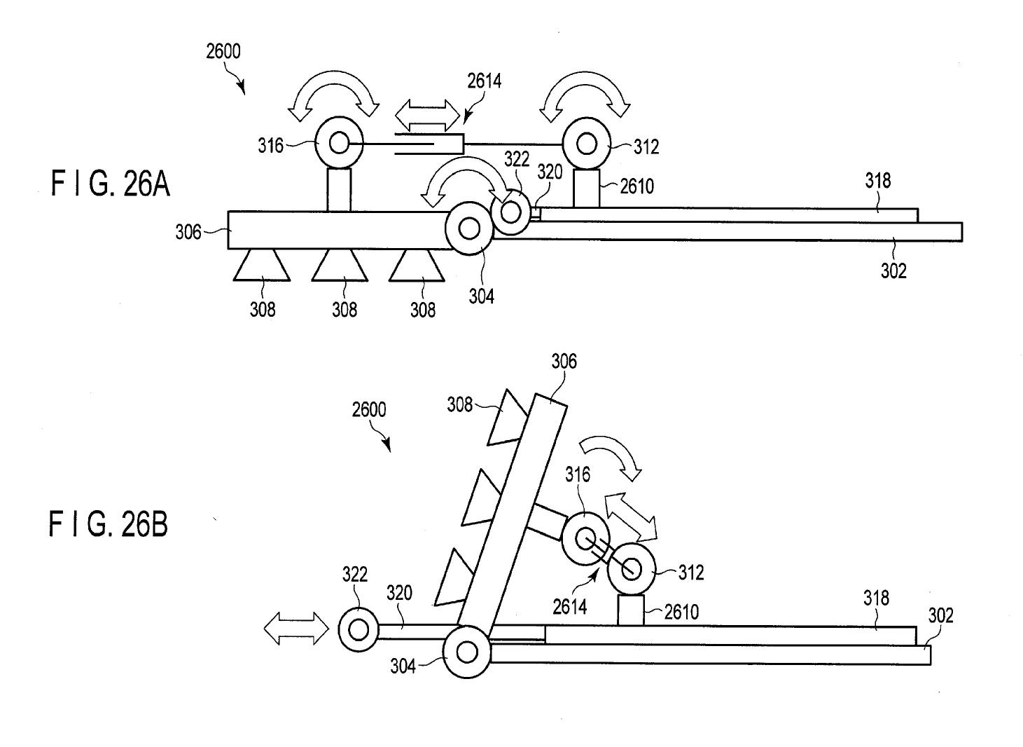

FIG. 26A is a side view schematically depicting a further modification of the holding device according to the first embodiment. In the modification depicted in FIG. 26A, a fixed part 2610 which is a part of the base part 302 is coupled to an extensible part 2614 which can be contracted and extended via the passive rotary joint 312. The extensible part 2614 is coupled to the base part 306 via the passive rotary joint 316. As depicted in FIG. 26B, contraction of the extensible part 2614 allows the base part 306 to rotate about the rotary axis 305 of the passive rotary joint 304. This eliminates the need to arrange, on the base part 302, a movable part such as the movable part 310 depicted in FIG. 3, allowing the base part 302 to be made compact. For example, the extensible part 2614 may be a configuration with a linear slider, a configuration with a combination of an electric motor and a rack pinion, a configuration using a pneumatic cylinder, or the like.

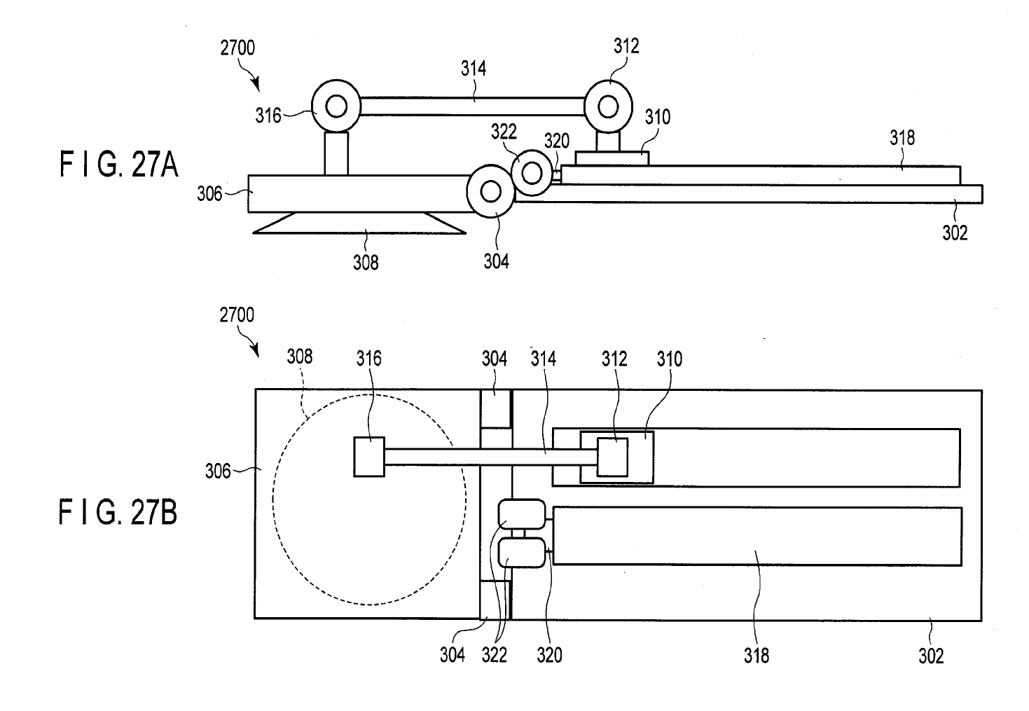

FIG. 27A and FIG. 27B are a side view and a top view schematically depicting another modification of the holding device according to the first embodiment. In the holding device 2700 depicted in FIG. 27A and FIG. 27B, one vacuum suction pad 308 is arranged on the base part 306.

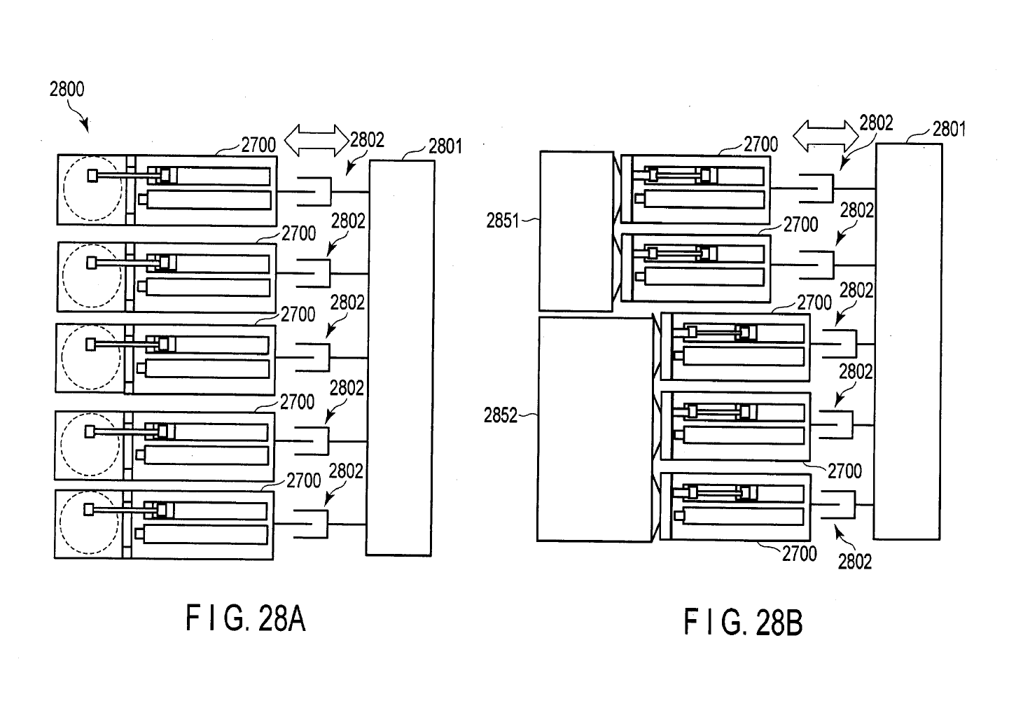

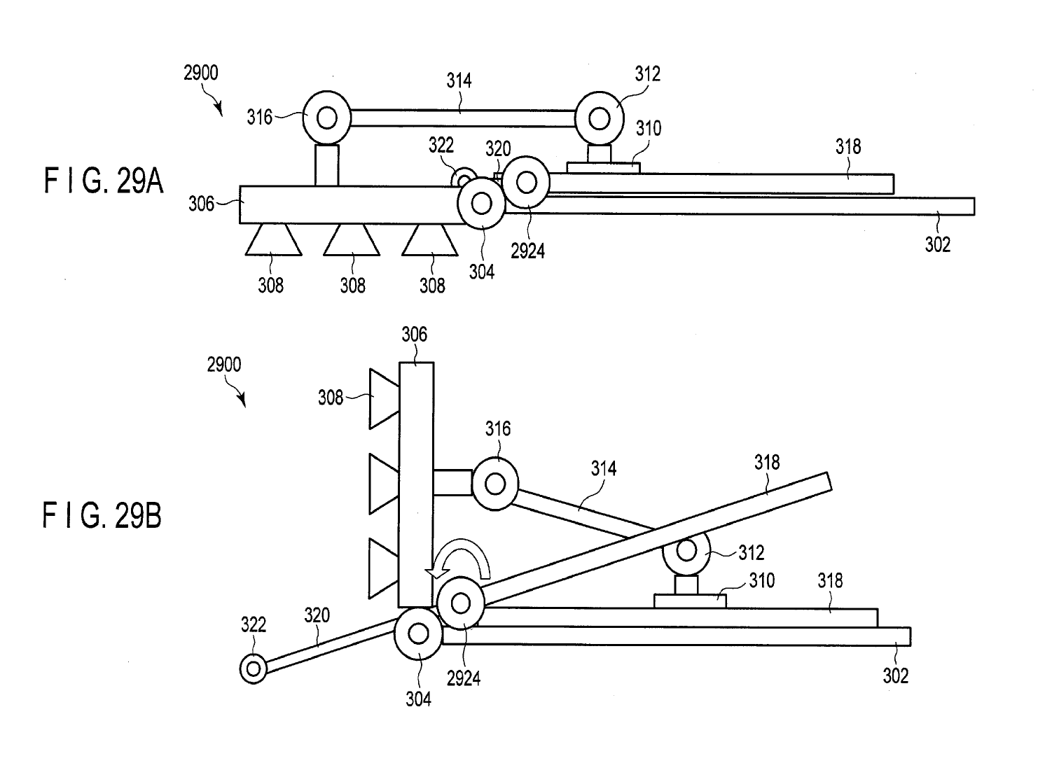

FIG. 28A is a top view schematically depicting a modification of the transfer device according to the first embodiment. A transfer device 2800 depicted in FIG. 28A includes a plurality of holding devices 2700 depicted in FIG. 27A. The holding devices 2700 are arranged in parallel and coupled to a base 2801 via an extensible part 2802 which can be contracted and extended. The extensible part 2802 and the base 2801 correspond to a manipulator. Provision of a plurality of the holding devices 2700 enables a variety of situations to be dealt with, for example, enables a plurality of articles to be simultaneously held. For example, as depicted in FIG. 28B, in the transfer device 2800, an article 2851 is held by two holding devices 2700 and an article 2852 is held by the remaining three holding devices 2700. This allows simultaneous holding of the articles 2851, 2852 having a front surface (a side surface located on the transfer device 2800 side) at different positions.

### Second Embodiment

FIG. 29A schematically depicts a variable article holding device 2900 according to a second embodiment. As depicted in FIG. 29A, the holding device 2900 includes a base part 302, a passive rotary joint 304, a base part 306, vacuum suction pads 308, a movable part 310, a passive rotary joint 312, a link member 314, a passive rotary joint 316, an active linear motion mechanism 318, a rod member 320, passive rollers 322, and an active rotary joint 2924. The holding device 2900 according to the present embodiment is different from the holding device 112 (FIG. 3A) according to the first embodiment in that the holding device 2900 includes the active rotary joint 2924.

The holding device 2900 has two modes, that is, an upper-surface suction mode in which the holding device 2900 holds an article depicted in FIG. 29A by sucking an upper surface thereof and a side surface suction mode in which the holding device 2900 holds an article depicted in FIG. 29B by sucking a side surface thereof. The holding device 2900 can be switched between the upper-surface suction mode and the side surface suction mode depending on the article to be taken out.

As depicted in FIG. 29B, the active linear motion mechanism 318 is coupled to the base part 302 via the active rotary joint 2924. The active linear motion mechanism 318 can rotate around a rotary axis of the active rotary joint 2924. Rotation of the active rotary joint 2924 varies the angle of the rod member 320 with respect to the base part 302.

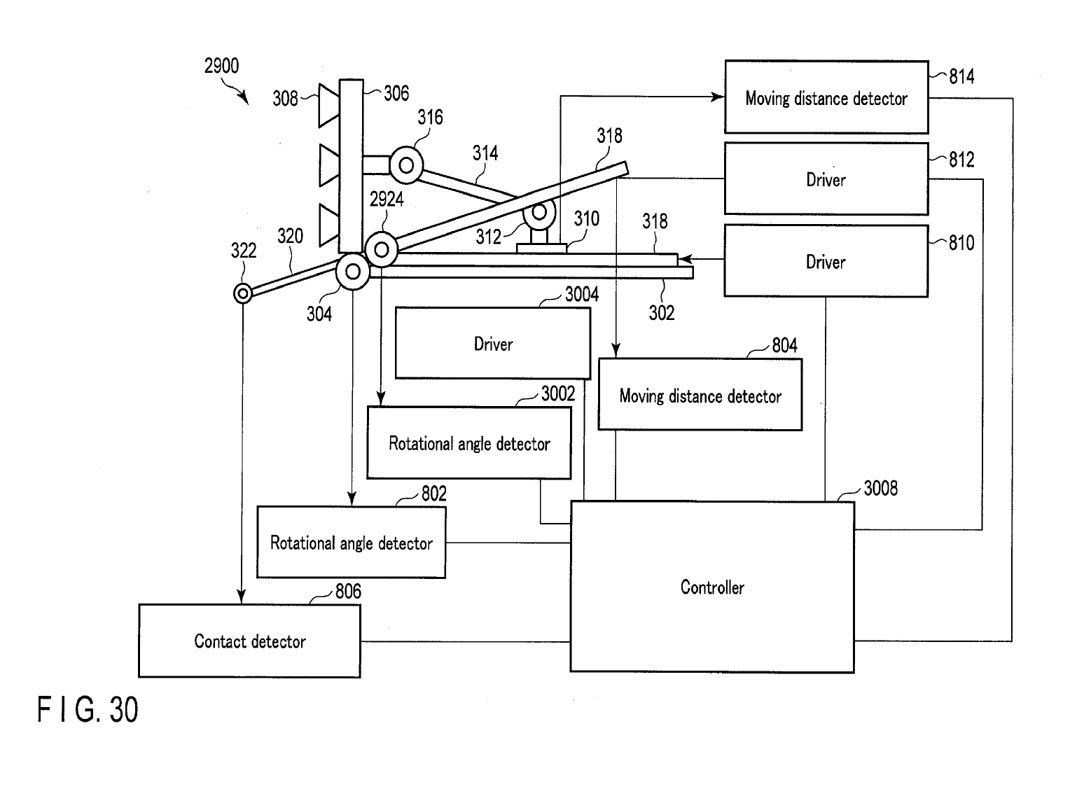

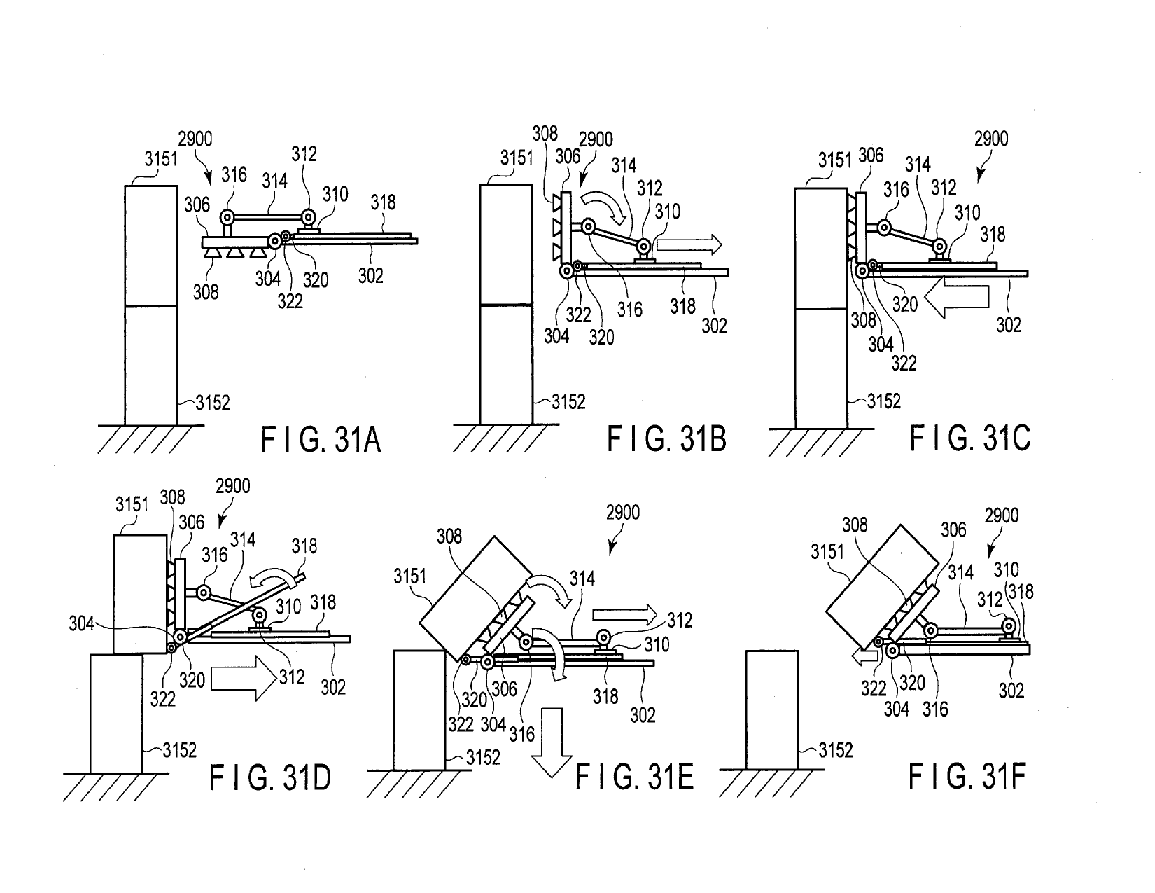

FIG. 30 schematically illustrates a control system for the holding device 2900. The control system illustrated in FIG. 30 includes a rotational angle detector 802, a moving distance detector 804, a contact detector 806, a moving distance detector 814, a controller 3008, a driver 810, a driver 812, a rotational angle detector 3002, and a driver 3004.

The controller 3008 controls the driver 810, the driver 812, and the driver 3004. For example, the controller 3008 generates a command including a rotation speed of the active rotary joint 2924 to provide the command to the driver 3004. The driver 3004 rotationally drives the active rotary joint 2924 in accordance with the command from the controller 808. The driver 3004 includes, for example, a motor. The rotational angle detector 3002 detects a rotational angle of the active rotary joint 2924 to feed information indicative of the detected rotational angle back to the controller 3008. The controller 3008 adjusts the rotation amount of the active rotary joint 2924 based on the information output from the rotational angle detector 3002.

With reference to FIGS. 31A to 31F, an example operation of the holding device 2900 in the side surface suction mode will be described. In FIGS. 31A to 31F, illustration of the active rotary joint 2924 is omitted. As depicted in FIG. 31A, an article 3151 is placed on an article 3152. The robot controller according to the present embodiment controls a transfer device including the holding device 2900 as described below. The holding device 2900 advances toward the article 3151. As depicted in FIG. 31B, the holding device 2900 changes the orientation of the base part 306 to the vertical direction such that the vacuum suction pads 308 lie opposite to a side surface of the article 3151. As depicted in FIG. 31C, the holding device 2900 moves further toward the article 3151. Subsequently, a process of detecting a lower end of the article 3151 is executed. In the present embodiment, provision of the active rotary joint 2924 allows extension of a movement range of the passive rollers 322. Specifically, control of the active rotary joint 2924 and the active linear motion mechanism 318 enables the sensor provided on the passive rollers 322 to be moved over a wide range. Consequently, the process of detecting the lower end of the article 3151 can be executed without the need to move the whole holding device 2900. The process of detecting the lower end of the article 3151 may be executed by moving the whole holding device 2900 as is the case with the first embodiment.

As depicted in FIG. 31D, the holding device 2900 moves forward until the vacuum suction pads 308 come into contact with the side surface of the article 3151. Then, the vacuum pump evacuates the vacuum suction pads 308 to allow the article 3151 to be held by the vacuum suction pads 308. The active rotary joint 2924 rotates, and the active linear motion mechanism 318 pushes the rod member 320 out such that the passive rollers 322 come into contact with the article 3151. The holding device 2900 moves slightly rearward. As depicted in FIG. 31E, the orientation of the base part 306 is changed so as to tilt the base part 306 to the base part 302 side, with the article 3151 pushed up by the rod member 320. Then, as depicted in FIG. 31F, the holding device 112 moves rearward to carry the article 3151.

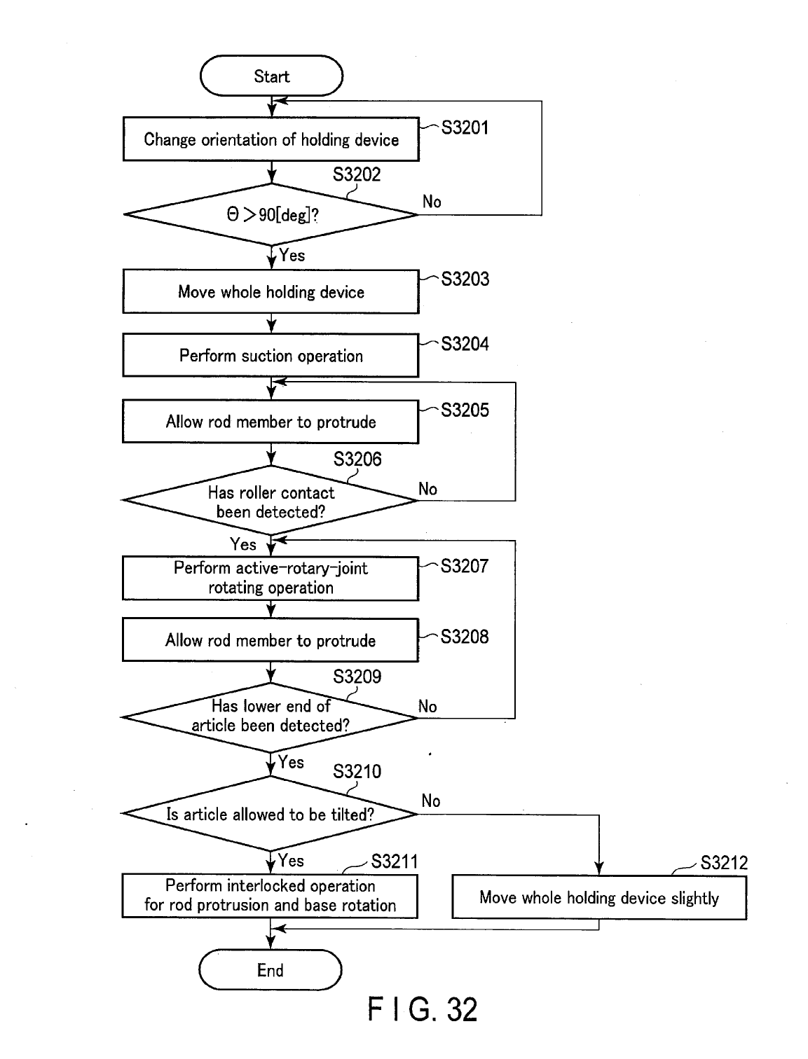

FIG. 32 illustrates an example operation in which the holding device 2900 carries the article in the side surface suction mode. In step S3201 in FIG. 32, the orientation of the holding device 2900 is changed. Specifically, the movable part 310 is moved in order to rotate the base part 306. The movable part 310 is moved until the base part 306 is placed at an angle θ of 90 degrees (step S3202). In step S3203, the holding device 2900 is moved. In step S3204, the holding device 2900 sucks and holds the target article. In step S3205, the rod member 320 is pushed outward. The rod member 320 is pushed out until the passive rollers 322 come into contact with the target article (step S3206).

In step S3207, the active rotary joint 2924 is rotationally driven. In step S3208, the rod member 320 is pushed out. In the meantime, the process of detecting the lower end of the target article is executed. When the lower end of the article is detected (step S3209), the robot controller determines in step S3210 whether or not the article is allowed to be tilted. Upon determining that the article is allowed to be tilted, the robot controller proceeds to step S3211, where an operation of rotating the rod member 320 and an operation of rotating the base part 306 are performed. Consequently, the holding device 2900 obliquely holds the target article as depicted in FIG. 31E. Upon determining that the article is not allowed to be tilted, the robot controller proceeds to step S3212, where the holding device 2900 moves by a predetermined distance.

The second embodiment can produce effects similar to the effects of the first embodiment. Moreover, in the second embodiment, the active linear motion mechanism 318 is coupled to the base part 302 via the active rotary joint 2924. This extends the range of directions in which the rod member 320 moves. As a result, in the process of detecting the lower end of the article, the need to move the whole holding device 2900 is eliminated or the moving distance of the holding device 2900 can be reduced. To tilt the article, a force which pushes the article up can be exerted.

The various processes described above in the embodiments can be executed based on programs which are software. For example, the processes can be implemented by a central processing unit (CPU) in a computer executing the programs. A part or all of the processes may be implemented by hardware such as application specific integrated circuits (ASICs).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A variable article holding device comprising:
a first base part;
a first holder which holds an article, the first holder being provided on the first base part;
a second base part rotatably supporting the first base part about a rotary axis;
a first driving mechanism which rotates the first base part;
a protruding member; and
a second driving mechanism which moves the protruding member in a direction crossing the rotary axis, the second driving mechanism being provided on the first base part.

2. The variable article holding device according to claim 1, wherein the first holder comprises a suction pad, and
the variable article holding device further comprises a negative-pressure generator which generates a negative pressure applied to the suction pad.

3. The variable article holding device according to claim 1, further comprising a second holder which holds an article, the second holder being provided on the second base part.

4. The variable article holding device according to claim 1, further comprising a passive roller provided at a tip portion of the protruding member.

5. The variable article holding device according to claim 1, wherein the protruding member made of an elastic material.

6. The variable article holding device according to claim 1, wherein the protruding member comprises a hollow main body made of an elastic material.

7. The variable article holding device according to claim 1, wherein the protruding member comprises a hollow main body made of an elastic material, and the main body is internally separated into a plurality of air chambers filled with particles with different particle sizes.

8. The variable article holding device according to claim 1, wherein the protruding member comprises a hollow main body made of an elastic material, a rod provided to be inserted into the main body, and a movement mechanism which to move the rod.

9. The variable article holding device according to claim 1, further comprising:
a first detector which detects a moving distance of the protruding member;
a second detector which detects that the protruding member has come into contact with the article;
a first controller which controls movement of the protruding member based on an output from the first detector and an output from the second detector;
a third detector which detects a rotation amount of the first base part; and
a second controller which controls rotation of the first base part based on an output from the third detector.

10. The variable article holding device according to claim 1, further comprising:
at least one of an image sensor or a range sensor provided at the tip portion of the protruding member; and
a fourth detector which detects a lower end of the article based on an output from the at least one of the image sensor or the range sensor.

11. The variable article holding device according to claim 1, further comprising a third driving mechanism which rotates the protruding member.

12. The variable article holding device according to claim 1, wherein the first driving mechanism comprises:
a movable part movably provided on the second base part;
a link member;
a first rotary joint coupling the movable part and the link member together;
a second rotary joint coupling the link member and the second base part together; and
a driver which moves the movable part.

13. The variable article holding device according to claim 1, wherein the first driving mechanism comprises:
an extensible part which contracts and extends;
a first rotary joint coupling the extensible part and the first base part together; and
a second rotary joint coupling the extensible part and the second base part together.

14. A transfer device comprising:
the variable article holding device according to claim 1; and
a manipulator which moves the variable article holding device.

15. A robot handling system comprising:
the transfer device according to claim 14;
a three-dimensional position recognizing device which recognizes a three-dimensional position of the article and generates information indicative of the three-dimensional position of the article; and
a controller which controls the transfer device based on the information.

16. A method for controlling a transfer device comprising a variable article holding device and a manipulator which moves the variable article holding device, the variable article holding device including a first base part, a holder which holds an article, the holder being provided on the first base part, a second base part rotatably supporting the first base part about a rotary axis, a first driving mechanism which rotates the first base part, a protruding member, and a second driving mechanism which moves the protruding member in a direction crossing the rotary axis, the second driving mechanism being provided on the first base part, the method comprising:
determining whether or not an upper surface of the article is allowed to be held;
controlling, upon determining that the upper surface is allowed to be held, a first operation in which the first driving mechanism rotates the first base part such that the holder lies opposite to the upper surface of the article, the manipulator moves the variable article holding device such that the holder comes into contact with the upper surface of the article, and the holder holds the article; and
controlling, upon determining that the upper surface is not allowed to be held, a second operation in which the first driving mechanism rotates the first base part such that the holder lies opposite to a side surface of the article, the manipulator moves the variable article holding device such that the holder comes into contact with the article, the holder holds the article, and the second driving mechanism moves the protruding member such that the protruding member comes into contact with the side surface of the article.
